(19) United States
(12) Patent Application Publication
(10) Pub. No.: US 2026/0054586 A1
(43) Pub. Date: Feb. 26, 2026

(54) VEHICLE CHARGING SYSTEMS

(71) Applicant: Rivian IP Holdings, LLC, Irvine, CA (US)

(72) Inventors: Wesley Reynolds, Redondo Beach, CA (US); Edward James Taylor, Truckee, CA (US); Takeshi Ouchi, Rolling Hills Estates, CA (US); Peter Mulqueen, Irvine, CA (US); Jeremy Francis Beckford, Torrance, CA (US)

(21) Appl. No.: 19/305,457

(22) Filed: Aug. 20, 2025

Related U.S. Application Data
(60) Provisional application No. 63/685,115, filed on Aug. 20, 2024.

(51) Int. Cl. B60L 53/31; B60L 53/18; H02J 7/00

(52) U.S. Cl. CPC B60L 53/31; B60L 53/18; H02J 7/0042

(57) ABSTRACT

A vehicle charging system includes one or more removable modules, one or more removable panels, and a holster configured to secure a charging coupler. A removable module includes, for example, a housing, a display screen attached to the housing, a user input interface attached to the housing, an electrical interface for coupling to the vehicle charging system, and control circuitry attached to the housing and coupled to the display screen, the user input interface, and the electrical interface. The removable holster includes a holster support, a holster skin to receive the charging cable coupler, and a retention feature configured to retain the charging cable coupler in the cavity of the holster skin. The vehicle charging system includes one or more trays, each having a slot for mounting and positioning the assembly inside a vehicle charging system. A busbar and at least one electrical component may be attached to the tray.

### CROSS-REFERENCE TO RELATED APPLICATIONS

This application claims the benefit of U.S. Provisional Patent Application No. 63/685,115, filed Aug. 20, 2024, the disclosure of which is hereby incorporated by reference herein in its entirety.

### INTRODUCTION

The present disclosure is directed to a system and method for a vehicle charging system, and more particularly to a system and method for improving manufacturability and serviceability of a vehicle charging system.

### SUMMARY

A vehicle charging system may provide power to a vehicle, such as to charge a battery of the vehicle. The vehicle charging system includes several systems, components, and/or assemblies that may be integrated or hardwired to each other or to other systems of the vehicle charging system. Servicing or maintaining the systems, components, or assemblies may require most or all of the troubleshooting and repair to be performed on-site. Working on-site may require a technician to work in or around environmental factors such as inclement weather (e.g., extreme heat, extreme cold, rain, sleet, wind, or snow) or undesirable conditions (e.g., unsafe locations, remote locations, dangerous animals, or pests such as insects). The vehicle charging system may remain offline or unusable until the servicing is complete, which may require several trips by the technician. Accordingly, there is a need to provide a vehicle charging system that is easier to service and maintain to reduce time the technician is exposed to such environmental factors. Such a solution leverages a modular and interchangeable design of systems, components, or assemblies of the vehicle charging system. To solve these problems, systems and methods are provided herein for improving manufacturability and serviceability of a vehicle charging system

In some embodiments, the present disclosure is directed to a removable module having a housing, a display screen, a user input interface, an electrical interface, and control circuitry. The housing is configured to couple and decouple the removable module to a vehicle charging system, for example. The display screen and the user input interface are attached to the housing, for example. The electrical interface is configured to electrically couple the removable module to the vehicle charging system, for example. The control circuitry is attached to the housing and coupled to the display screen, the user input interface, and the electrical interface. In some embodiments, decoupling the housing from the vehicle charging system enables the removable module, including the housing, display screen, user input interface, electrical interface, and control circuity, to be removed from the vehicle charging system as a single unit.

In some embodiments, the removable module includes a payment module attached to the housing and configured to process payment. In some such embodiments, the control circuitry is coupled to the payment module, and the removable module includes the payment module as part of the single unit. In some embodiments, the payment module comprises a tap to pay reader. In some embodiments, the removable module includes a payment light source attached to the housing and configured to denote a location of the tap to pay reader. In some such embodiments, the control circuitry is coupled to the payment light source, and the removable module includes the payment light source as part of the single unit. In some embodiments, the electrical interface includes a plurality of cables, each respective cable of the plurality of cables having a connector for coupling the respective cable to circuitry of the vehicle charging system. In some such embodiments, the control circuitry and the payment module are each coupled to one of the plurality of cables, and the removable module includes the plurality of cables and the connectors as part of the single unit. In some embodiments, the electrical interface includes a cable having a connector for coupling the cable to circuitry of the vehicle charging system, the control circuitry is coupled to the cable, and the removable module includes the cable and the connector as part of the single unit.

In some embodiments, the removable module includes a holster light source attached to the housing, and a light pipe configured to direct light emitted from the holster light source to a holster assembly of the vehicle charging system. In some such embodiments, the control circuitry is coupled to the holster light source, and the removable module includes the holster light source and the light pipe as part of the single unit. In some embodiments, the user input interface includes a button configured to receive input for the removable module. In some embodiments, the control circuitry is configured to, based at least in part on an interaction with the button, provide power to a charging cable of the vehicle charging system. In some embodiments, the button is attached to the housing with two fasteners. In some embodiments, the housing is configured to be coupled to the vehicle charging system with six or less total fasteners.

In some embodiments, the present disclosure is directed to a method that includes electrically decoupling an electrical interface of a removable module from a vehicle charging system, mechanically decoupling the removable module from the vehicle charging system, and removing the removable module, including a housing, a display screen, a user input interface, the electrical interface, and control circuity, from the vehicle charging system as a single unit. In some embodiments, mechanically decoupling includes removing at least one fastener securing the housing to the vehicle charging system. In some embodiments, the electrical interface includes a plurality of cables, each respective cable of the plurality of cables having a connector, and electrically decoupling the electrical interface from the vehicle charging system includes decoupling the connector of each respective cable from circuitry of the vehicle charging system. In some such embodiments, the removable module includes the plurality of cables and the connectors as part of the single unit. In some embodiments, the electrical interface includes a cable having a connector, electrically decoupling the electrical interface to the vehicle charging system includes decoupling the cable from circuitry of vehicle charging system, the control circuitry is coupled to the cable, and the removable module includes the cable and the connector as part of the single unit. In some embodiments, the removable module includes a payment module attached to the housing and coupled to the control circuitry, and the removable module includes the payment module as part of the single unit. In some embodiments, the method includes inserting a replacement removable module into a vehicle charging system, and the replacement removable module, including a housing, a display screen, a user input interface, the electrical interface, and control circuity, is inserted into the vehicle charging system as a single unit. In some embodiments, the method includes electrically coupling an electrical interface of the replacement removable module to the vehicle charging system, and mechanically coupling the replacement removable module to the vehicle charging system. In some embodiments, the method includes directing light emitted from a holster light source to a holster assembly of the vehicle charging system using a light pipe. In some such embodiments, the holster light source is attached to the housing, the control circuitry is coupled to the holster light source, and the removable module includes the holster light source and the light pipe as part of the single unit.

In some embodiments, the present disclosure is directed to a method that includes inserting a removable module into a vehicle charging system, electrically coupling an electrical interface of the removable module to the vehicle charging system, and mechanically coupling the removable module to the vehicle charging system. In some embodiments, the removable module, including a housing, a display screen, a user input interface, the electrical interface, and control circuity, is inserted into the vehicle charging system as a single unit.

In some embodiments, the present disclosure is directed to an apparatus that includes a holster support, a holster skin forming a cavity to receive a charging cable coupler, and a retention feature configured to retain the charging cable coupler in the cavity of the holster skin. In some embodiments, the holster skin is removably coupled to the holster support and configured to be disposed between the holster support and the charging cable coupler. In some embodiments, the cavity is formed having an entry portion and a retaining portion, the entry portion is configured to guide the charging cable coupler to the retaining portion, and the retaining portion is configured to receive the charging cable coupler. In some embodiments, the retaining portion is configured to form a friction fit with the charging cable coupler to retain the charging cable coupler in the cavity. In some embodiments, the retention feature includes a pin coupled to the holster support and disposed between two sidewalls of the retaining portion of the cavity. In some embodiments, the holster support includes support ribs configured to support a force of the charging cable coupler when the charging cable coupler is retained. In some embodiments, the holster support includes locator ribs configured to limit movement of the charging cable coupler in a vertical direction and permit movement of the charging cable coupler in a horizontal direction. In some embodiments, the holster skin forms an opening or includes a semi-transparent or transparent material, configured to receive light from a light source to illuminate the cavity. In some embodiments, the apparatus includes a removable panel having an opening, wherein the holster skin is arranged such that the cavity of the holster skin at least partially passes through the opening and the charging cable coupler extends through the opening when the charging cable coupler is retained in the cavity of the holster skin. In some embodiments, the holster skin includes a tab configured to engage a slot of the removable panel to attach the holster skin to the removable panel.

In some embodiments, the present disclosure is directed to a vehicle charging system that includes a charging cable having a coupler for coupling to a charging port of a vehicle, a removable panel, a holster support attached to the removable panel, a holster skin forming a cavity to receive a charging cable coupler, and a pin configured to engage a latch of the coupler to retain the coupler in the cavity of the holster skin. In some embodiments, the holster skin is removably coupled to the holster support and configured to be disposed between the holster support and the coupler.

In some embodiments, the present disclosure is directed to a method that includes coupling a holster skin to a holster support of a vehicle charging system. In some embodiments, the holster skin forms a cavity to receive a charging cable coupler, and a retention feature is configured to retain the charging cable coupler in the cavity of the holster skin. In some embodiments, the method includes attaching the holster skin to a removable panel of the vehicle charging system such that the cavity of the holster skin at least partially passes through an opening in the removable panel. In some such embodiments, the charging cable coupler extends through the opening when the charging cable coupler is retained in the cavity. In some embodiments, attaching the holster skin to the removable panel includes inserting a tab of the holster skin into a slot of the removable panel. In some embodiments, the method includes attaching the holster support to the vehicle charging system. In some embodiments, the method includes attaching the holster support to at least one of a removable panel or a removable module of the vehicle charging system. In some embodiments, the cavity is formed having an entry portion and a retaining portion, the entry portion is configured to guide the coupler to the retaining portion, and the retaining portion is configured to receive the coupler. In some embodiments, the retention feature includes a pin coupled to the holster support and disposed between two sidewalls of the retaining portion of the cavity. In some embodiments, the method includes supporting a force of the charging cable coupler when the charging cable coupler is retained using support ribs of the holster support. In some embodiment, the method includes forming the holster skin as a single, unitary component. In some embodiments, the method includes decoupling the holster skin from the holster support after coupling the holster skin.

In some embodiments, the present disclosure is directed to an assembly that includes a tray having a slot for removably mounting and positioning the assembly inside a vehicle charging system, a rigid busbar attached to the tray and configured to removably couple to a charging cable for the vehicle charging system, and at least one electrical component attached to the tray. In some embodiments, the tray is configured to engage with the vehicle charging system, in a first position, using a fastener positioned in a first region of the slot, and the rigid busbar is configured to couple to the charging cable when the tray is in a second position and the fastener is positioned in a second region of the slot. In some embodiments, the tray is configured to engage with the vehicle charging system using a fastener positioned in the slot, and the slot and the fastener are configured to guide movement of the tray to a second position for the rigid busbar to couple to the charging cable. In some embodiments, the slot is a t-shaped slot configured to receive a fastener, a first region of the t-shaped slot is configured to guide movement of the tray from a first position to an intermediate position, and a second region of the t-shaped slot is configured to guide movement of the tray from the intermediate position to a second position. In some such embodiments, the slot receives the fastener in the first position, and the rigid busbar couples to the charging cable in the second position. In some embodiments, a first leg of the t-shaped slot is configured to guide movement of the tray in a first direction, and a second leg of the t-shaped slot is configured to guide movement of the tray in a second direction that is angled with respect to the first direction. In some embodiments, the tray has at least two slots configured to removably mount the assembly to two walls of the vehicle charging system. In some embodiments, the assembly includes a ground patch configured to ground the tray to the vehicle charging system. In some embodiments, the assembly includes a terminal block having screw terminals configured to electrically couple and decouple the rigid busbar to the charging cable. In some embodiments, the at least one electrical component includes high-voltage direct current components. In some embodiments, the at least one electrical component includes low-voltage direct current components.

In some embodiments, the present disclosure is directed to a method that includes positioning a tray inside a vehicle charging system such that a fastener of the vehicle charging system engages with a slot of the tray, moving the tray in a first direction such that the fastener moves in relation to the slot, and coupling a rigid busbar of the tray to a charging cable for the vehicle charging system. In some embodiments, positioning the tray inside the vehicle charging system includes positioning the tray in a first position with the fastener positioned in a first region of the slot, and the rigid busbar is configured to couple to the charging cable when the tray is in a second position and the fastener is positioned in a second region of the slot. In some embodiments, the slot and the fastener are configured to guide movement of the tray to a second position, and the rigid busbar is coupled to the charging cable when the tray is in the second position. In some such embodiments, the method includes attaching the tray to the vehicle charging system when the tray is in the second position. In some embodiments, the slot is a t-shaped slot, the tray moves in the first direction by using a first region of the t-shaped slot to guide movement of the tray from a first position to an intermediate position, and the method includes moving the tray in a second direction by using a second region of the t-shaped slot to guide movement of the tray from the intermediate position to a second position. For example, the rigid busbar is coupled to the charging cable in the second position. In some embodiments, a first leg of the t-shaped slot guides the movement of the tray in the first direction, a second leg of the t-shaped slot is configured to guide movement of the tray in the second direction, and the second direction is angled with respect to the first direction. In some embodiments, the method includes attaching the tray to a first wall of the vehicle charging system, in a first position, using the fastener positioned in the slot, and attaching the tray to a second wall of the vehicle charging system, in a second position, using a fastener positioned in a different slot of the tray. In some embodiments, the method includes attaching the tray to the vehicle charging system such that a tray ground patch contacts a frame ground patch of the vehicle charging system. In some embodiments, the method includes electrically coupling the rigid busbar to the charging cable using a terminal block having screw terminals. In some embodiments, at least one high-voltage direct current component is attached to the tray, and at least one low-voltage direct current component is attached to the tray.

In some embodiments, the present disclosure is directed to a vehicle charging system having at least one removable panel arranged to cover an opening, a charging cable having a charging coupler, and an assembly electrically coupled to the charging cable. The assembly includes a tray having a slot for removably mounting and positioning the assembly inside the vehicle charging system, a rigid busbar attached to the tray and configured to removably couple to a charging cable for the vehicle charging system, and at least one electrical component attached to the tray. In some such embodiments, the assembly is removable through the opening when the at least one removable panel is removed.

In some embodiments, the present disclosure is directed to a system having a first removable panel that includes a first alignment feature and configured to attach to a frame, and a second removable panel. The second removable panel includes a second alignment feature configured to engage with the first alignment feature to maintain a spacing between the first and second removable panels, and a magnetic feature configured to hold the second removable panel in a position to enable the second removable panel to be attached to the frame, for example. In some embodiments, the first alignment feature is one of a first pin or a hole, and the second alignment feature is the other of the first pin or the hole. In some embodiments, the first removable panel includes a third alignment feature, the second removable panel includes a fourth alignment feature, the third alignment feature is one of a second pin or a slot, and the fourth alignment feature is the other of the second pin or the slot.

In some embodiments, the second removable panel includes a first support feature configured to engage with a second support feature of the frame to support the second removable panel before the second alignment feature engages with the first alignment feature. In some embodiments, the first support feature includes one of a hook or a loop, the second support feature includes the other of the hook or the loop, and the hook is configured to catch an opening of the loop when the first support feature engages with the second support feature.

In some embodiments, the first removable panel includes a fifth alignment feature to engage a sixth alignment feature of the frame. In some such embodiments, the fifth alignment feature is one of a pin or a hole, and the sixth alignment feature is the other of the pin or the hole. In some embodiments, the first removable panel includes a seventh alignment feature to engage an eighth alignment feature of the frame. In some such embodiments, the seventh alignment feature is one of a pin or a slot, and the eighth alignment feature is the other of the pin or the slot.

In some embodiments, the system includes a fourth removable panel having a tenth alignment feature. In some such embodiments, the first removable panel includes a ninth alignment feature, and the tenth alignment feature is configured to engage with the ninth alignment feature to maintain a spacing between the first and fourth removable panels.

In some embodiments, the system includes a fifth removable panel having a fourteenth alignment feature. In some such embodiments, the second removable panel includes a thirteenth alignment feature, and the fourteenth alignment feature is configured to engage with the thirteenth alignment feature to maintain a spacing between the second and fifth removable panels. In some embodiments, the fifth removable panel includes a first retaining feature, the fourth removable panel further includes a second retaining feature, and the first retaining feature is configured to engage with the second retaining feature to attach the fifth removable panel to the fourth removable panel. In some embodiments, the thirteenth and fourteenth alignment features are configured to guide movement of the first retaining feature towards and into the second retaining feature. In some embodiments, the first removable panel includes an eleventh alignment feature and a thirteenth alignment feature, and the fourth removable panel includes both a twelfth alignment feature configured to engage with the eleventh alignment feature and a fourteenth alignment feature configured to engage with the thirteenth alignment feature. In some embodiments, the ninth and thirteenth alignment features are each a one of a horizontal slot or a vertical slot, and the eleventh alignment feature is the other of the horizontal slot or the vertical slot.

In some embodiments, the second removable panel forms an opening to allow access to a display screen of a removable module. In some embodiments, the second removable panel forms an opening to allow access to a holster skin configured to receive a charging cable coupler.

In some embodiments, the present disclosure is directed to a method that includes attaching a first removable panel to a frame, aligning a second removable panel to the first removable panel by engaging a second alignment feature of the second removable panel with the first alignment feature, holding the second removable panel against the frame using a magnetic feature of the second removable panel, and attaching the second removable panel to the frame. In some embodiments, the first removable panel comprising a first alignment feature. In some embodiments, the method includes engaging a first support feature of the second removable panel with a second support feature of the frame, and coupling the second removable panel to the frame. In some embodiments, the method includes aligning a fourth removable panel to the first removable panel by engaging a fourth alignment feature of the fourth removable panel with a third alignment feature of the first removable panel.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIGS. 1A and 1B show perspective views of a vehicle charging system, in accordance with some embodiments of the disclosure;

FIGS. 2A and 2B show perspective views of removable assemblies of a vehicle charging system, in accordance with some embodiments of the disclosure;

FIGS. 3A and 3B show perspective views of a removable module of the removable assemblies of FIGS. 2A and 2B, in accordance with some embodiments of the disclosure;

FIGS. 4A and 4B are a flowcharts of illustrative processes for removing or installing a removable module from a vehicle charging system, in accordance with some embodiments of the disclosure;

FIGS. 5A and 5B show views of illustrative holster assemblies, in accordance with some embodiments of the disclosure;

FIG. 6 is a schematic cutaway illustration of a holster assembly, in accordance with some embodiments of the disclosure;

FIG. 7A is a schematic illustration of a holster skin of a holster assembly, in accordance with some embodiments of the disclosure;

FIG. 7B is a partially transparent illustration of a holster assembly, in accordance with some embodiments of the disclosure;

FIG. 8A is a flowchart of an illustrative process for installing a holster skin in a vehicle charging system, in accordance with some embodiments of the disclosure;

FIG. 8B is a flowchart of an illustrative process for removing a holster skin from a vehicle charging system, in accordance with some embodiments of the disclosure;

FIGS. 9A-9C show respective views of a portion of a vehicle charging system, including one or more tray assemblies, in accordance with some embodiments of the disclosure;

FIGS. 10 and 11 show perspective views of portions of the vehicle charging system of FIGS. 9A-9C, in accordance with some embodiments of the present disclosure;
, in accordance with some embodiments of the disclosure;

FIG. 12 is a flowchart of an illustrative process for installing a tray of electrical components in a vehicle charging system, in accordance with some embodiments of the disclosure;

FIGS. 13A and 13B show perspective views of a vehicle charging system, in accordance with some embodiments of the disclosure;

FIG. 14A is a schematic illustration of removable panels, in accordance with some embodiments of the disclosure;

FIG. 14B is schematic illustration of alignment features of a frame, in accordance with some embodiments of the disclosure;

FIG. 15 is a schematic illustration of removable panels, in accordance with embodiments of the disclosure;

FIG. 16 is a schematic illustration of removable panels, in accordance with some embodiments of the disclosure;

FIG. 17 is a schematic illustration of removable panels, in accordance with some embodiments of the disclosure; and

FIG. 18 is a flowchart of an illustrative process for assembling removable panels of a vehicle charging system, in accordance with some embodiments of the disclosure.

### DETAILED DESCRIPTION

A vehicle charging system is provided that includes systems, components, or assemblies that are easily serviceable or replaceable. In one approach, the vehicle charging system includes any of a removable module, holster assembly, tray assembly, or removable panels. Such features may improve serviceability or maintainability and may increase availability of the vehicle charging system as discussed below.

The removable module combines multiple user interface electrical systems into a single, self-contained module. The systems may include any of a display, payment module, lighting, circuitry for the module, and a button. The button is used to accept an input from a user and may be replaced separately from the rest of the removable module to accommodate scenarios where the button is a high-wear or frequently replaced item. The button may be separately mounted to the removable module or to the vehicle charging system. Cables connect the removable module to other electronics or circuitry of the vehicle charging system. Fasteners may attach the removable module to the vehicle charging system. The cables and fasteners may enable easier removal and installation of the removable module when compared to a vehicle charging system that integrates or hardwires the systems of the removable module into circuitry for other systems of the vehicle charging system.

The holster assembly receives and stows a charging cable coupler. The holster assembly includes a removable holster skin, a holster support, and a retention feature. The holster skin may be coupled to the holster support using a single fastener, which may allow easy removal of the skin. The holster skin forms a cavity, and the retention feature is exposed within the cavity. The cavity receives the charging cable coupler, and the pin retains the coupler in the cavity. The cavity may be shaped to form a friction fit to retain the coupler, which may provide a secondary retention mechanism if the retention feature fails. The holster skin may be located in between the holster support and the coupler, and the holster support supports the weight of the coupler. The holster assembly may increase serviceability of the vehicle charging system by allowing easy removal and installation the holster skin, which may be a high-wear or frequently replaced item.

The tray assembly is removable from the vehicle charging system and includes a tray, rigid busbar, and electrical components mounted to the tray. The tray includes slots, which allow the tray assembly to be installed in a space-constrained environment, such as inside the vehicle charging system. The slots may guide movement of the tray from a first position, where the tray assembly is positioned inside the system, to a second position, where the tray assembly is attached to the system and the rigid busbar is coupled to the vehicle charging cable. The tray may move in a first direction, from the first position to an intermediate position, and in a second direction, from the intermediate position to the second position. The electrical components may include high-voltage direct current (HVDC) components. Including the HVDC components on the tray may increase manufacturability because the tray assembly may be assembled outside of the vehicle charging system in a non-space-constrained environment. Including the HVDC components on the tray may increase serviceability because the tray assembly may be removed and replaced with another tray assembly. The tray may increase serviceability of the vehicle charging system by guiding the tray assembly to cables of the charging cable when compared to manipulating the cables, which may be stiff, out of the way when installing the tray assembly.

The removable panels couple to one another and form an exterior shell of the vehicle charging system. A first removable panel attaches to a frame of the vehicle charging system and a second removable panel couples to the first removable panel. The removable panels use combinations of alignment features, support features, and retention features to removably couple to one another and to attach to the frame, which may improve assembly and serviceability when compared to using only fasteners and Christmas tree clips. The features include any of hooks, loops, magnetic material, slots, pins, or fasteners. The alignment features maintain alignment of the panels and spacing or gaps between the panels when the removable panels are coupled to one another. The alignment features may maintain the spacing without requiring tight tolerances of the panels or of positioning of features of the panels, which may improve manufacturability of the panels.

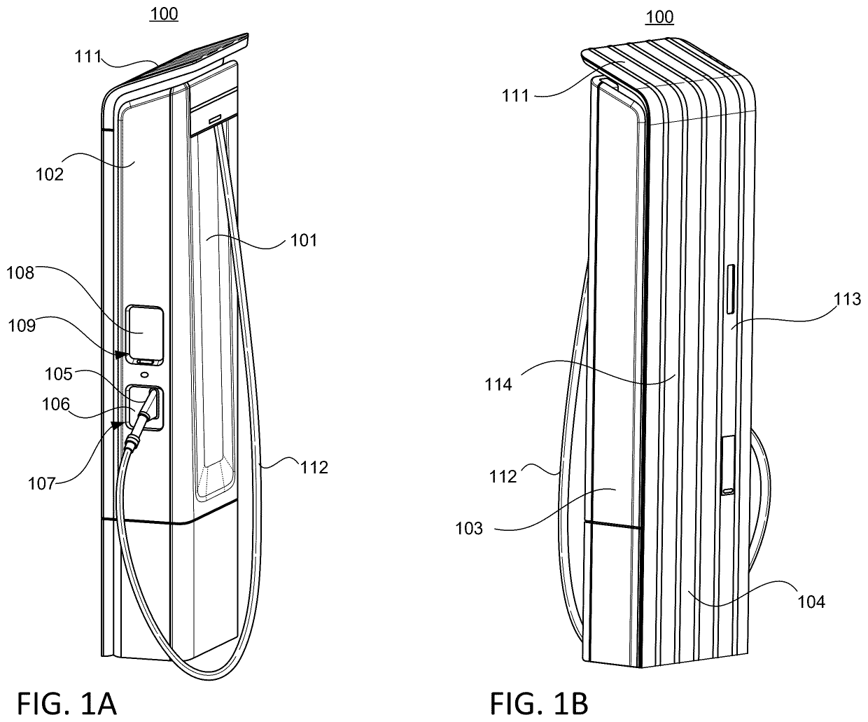

FIGS. 1A and 1B show perspective views of vehicle charging system 100, in accordance with embodiments of the disclosure. Vehicle charging system 100 may be used to provide power to a vehicle, which may be any one of a hybrid, plug-in hybrid, or electric vehicle. As illustrated, vehicle charging system 100 includes:
first removable panel 101;
second removable panel 102;
third removable panel 103;
system lower panel 104;
charging cable coupler 105;
holster assembly 106;
removable panel holster opening 107;
removable module 108;
removable panel module opening 109;
vehicle charging system 110;
roof 111;
vehicle charging cable 112;
system door 113; and
system access panel 114.

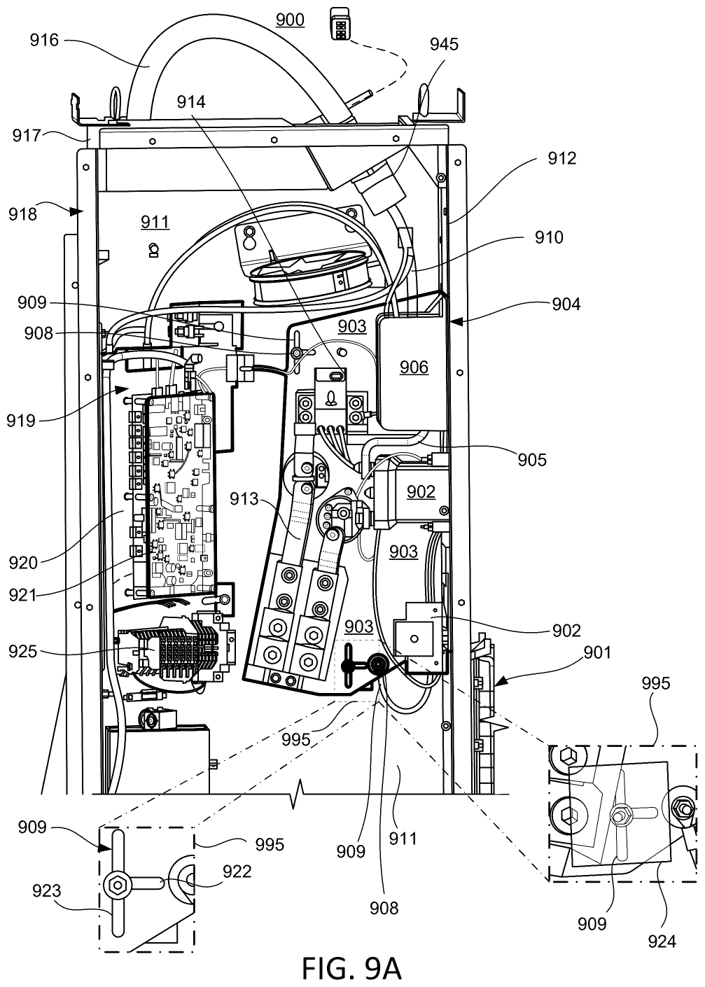

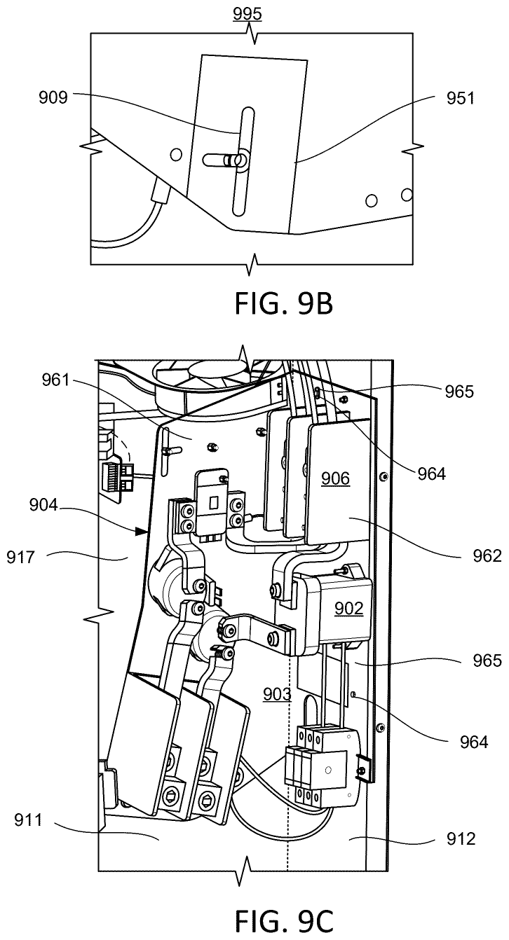

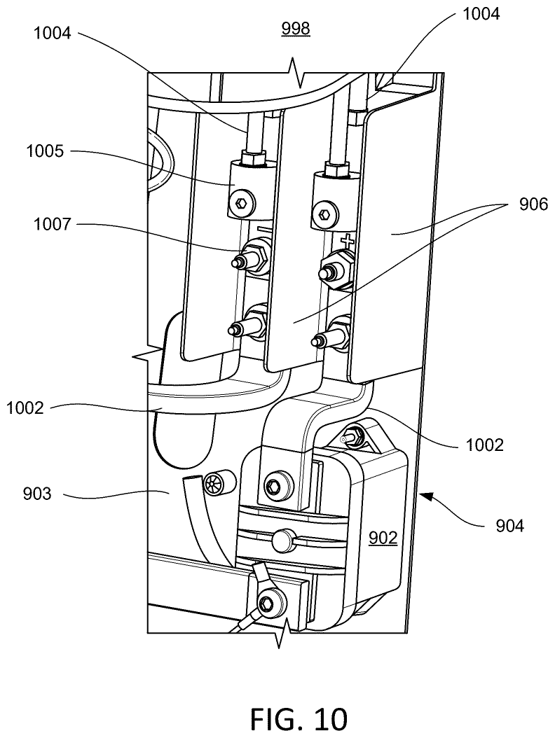

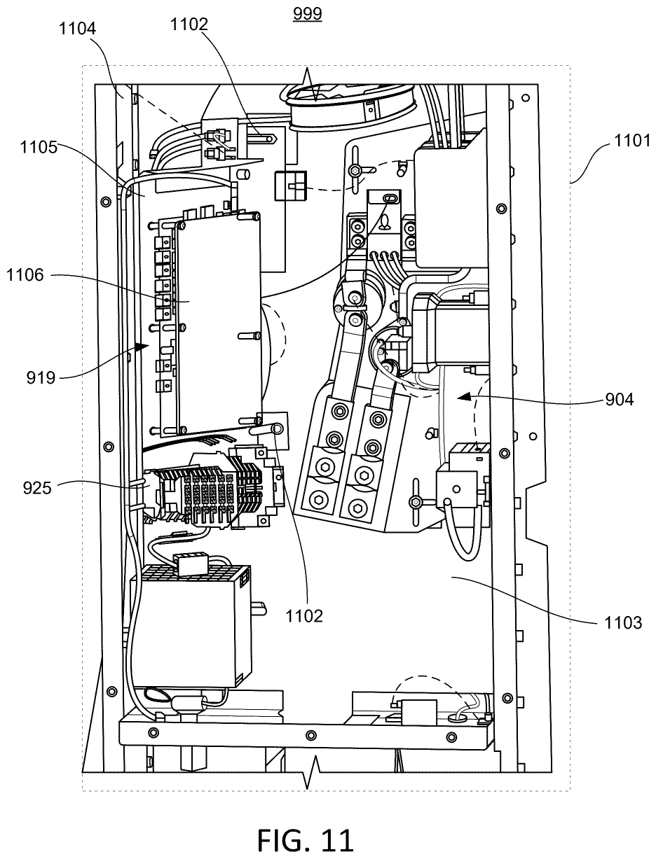

As illustrated, vehicle charging system 100 includes four lateral sides and roof 111. In some embodiments, although not illustrated, vehicle charging system 100 may include greater or fewer sides, a different geometric configuration, or a combination thereof. Vehicle charging system 100 includes system access panel 114, second removable panel 102, roof 111, several removable panels that surround a frame (see, e.g., FIGS. 9A, 9C, 14B, and 17), removable module 108, holster assembly 106, and vehicle charging cable 112 having a vehicle charging cable coupler 105. In some embodiments, system access panel 114, system lower panel 104, and roof 111 attach to each other and/or the frame. System access panel 114 may be attached to the frame by a hinge such that system access panel 114 rotates around the hinge axis and forms system door 113 that may be used to access the inside of vehicle charging system 110. In some embodiments, system access panel 114 includes system door 113 that moves in relation to system access panel 114. In some implementations, a hinge attaches system door 113 to system access panel 114. In some embodiments, system door 113 is used to access any of the frame, electronics, electrical connections or cables, retaining features such as fasteners, or other components that are inside vehicle charging system 110.

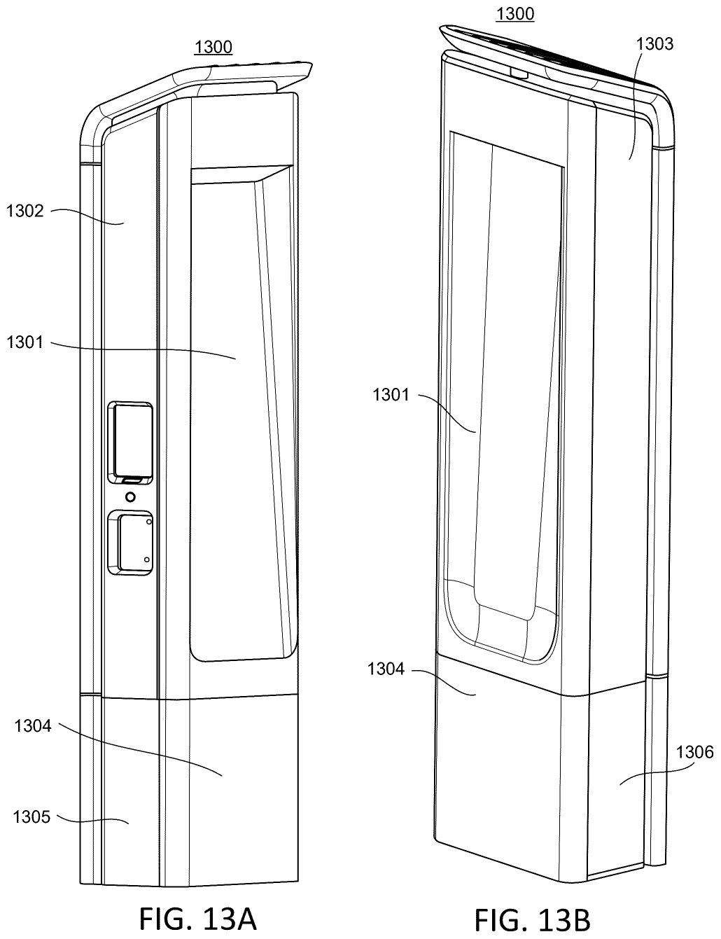

As illustrated, vehicle charging system 100 includes a plurality of removable panels. The removable panels include first removable panel 101, second removable panel 02, and third removable panel 103. Second removable panel 102 forms removable panel module opening 109, through which removable module 108 is visible or accessed and removable panel holster opening 107 through which holster assembly 106 is accessed. The remaining removable panels (e.g., fourth removable panel, fifth removable panel, and sixth removable panel) are labeled in FIGS. 13A and 13B. Removable modules 108 attach to one another and at least one of removable modules 108 attaches to the frame. In some embodiments, the removable panels are removed or installed independent of system access panel 114, system lower panel 104, and roof 111. In some implementations, the removable panels do not attach to any of system access panel 114, system lower panel 104, or roof 111.

In an illustrative example, removable module 108 functions as the interface for vehicle charging system 110. In some embodiments, removable module 108 is a human machine interface (HMI) module. Removable module 108 is configured to be installed and removed from vehicle charging system 100 as a single unit, which allows removable module 108 to be replaced or removed for service. The removable nature of removable module 108 may decrease time required to repair or service vehicle charging system 100 and may increase uptime of vehicle charging system 100.

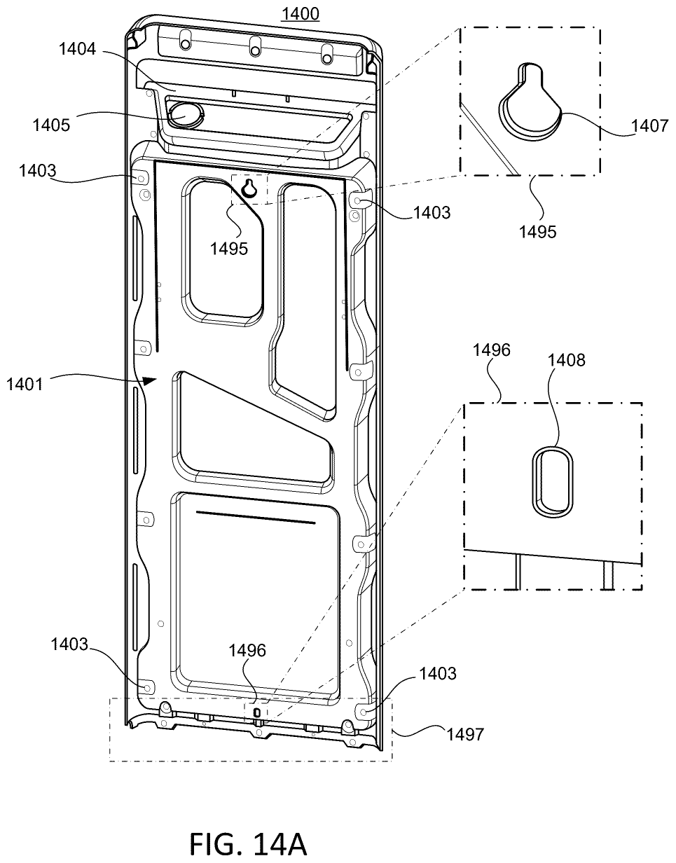

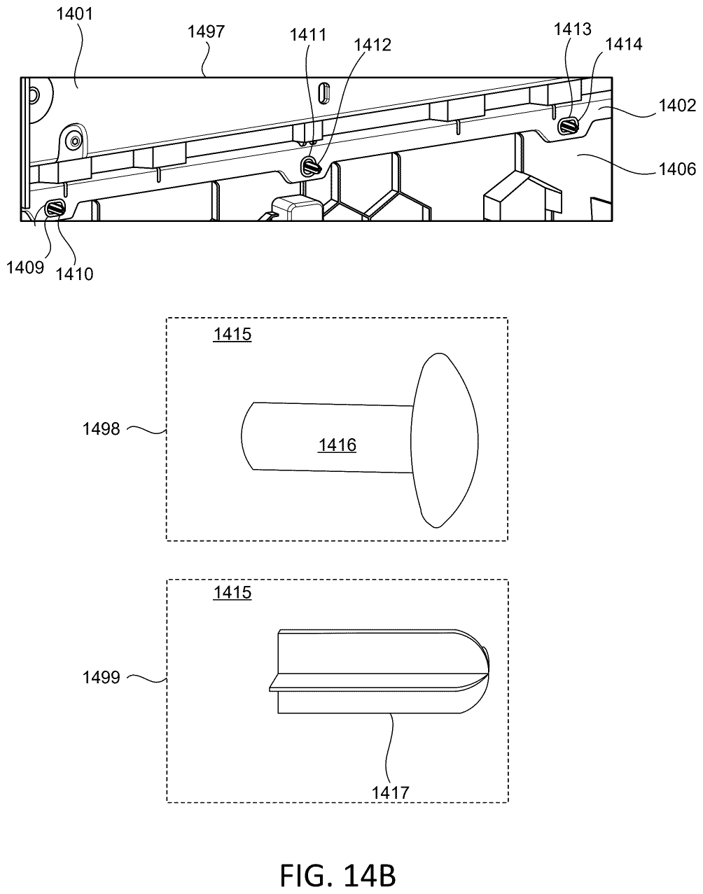

Vehicle charging cable 112 connects to electronics inside vehicle charging system 100 at one end and includes charging cable coupler 105 at the other end. In some embodiments, vehicle charging cable 112 connects to, or is electrically couped to, HVDC components inside vehicle charging system 100. As illustrated in FIG. 1B, vehicle charging cable 112 travels from the exterior of vehicle charging system 100 to the interior through a cable opening formed in a ledge, lip, or recessed portion of first removable panel 101. In some embodiments, the cable opening is larger than the cable exterior. In some embodiments, such as described below in relation to FIG. 14A, a seal is formed between the cable opening and the charging cable. Charging cable coupler 105 may connect to a charging port of a vehicle. In the embodiment depicted in FIG. 1A, charging cable coupler 105 is stowed inside holster assembly 106.

In some embodiments, a vehicle charging station includes several vehicle charging systems 110, which may be electrically coupled to a common power source and management system. In some embodiments, for example, the vehicle charging system is a vehicle charging station configured to provide charging to a plurality of vehicles simultaneously.

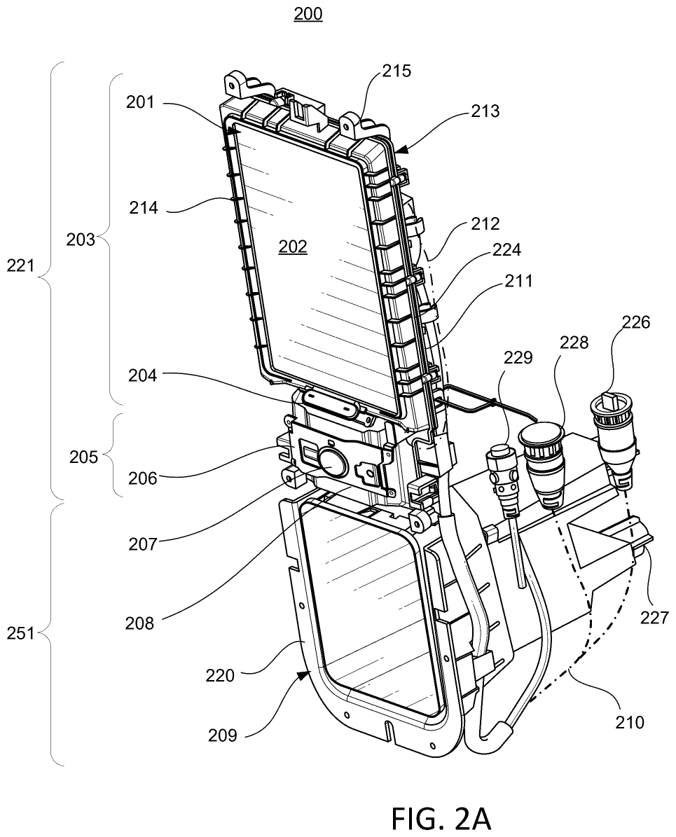

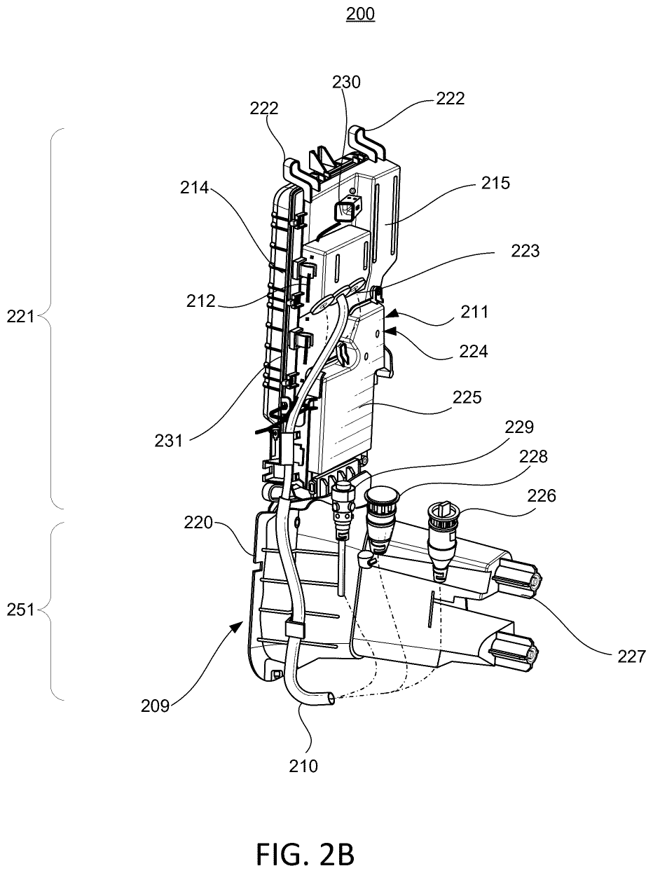

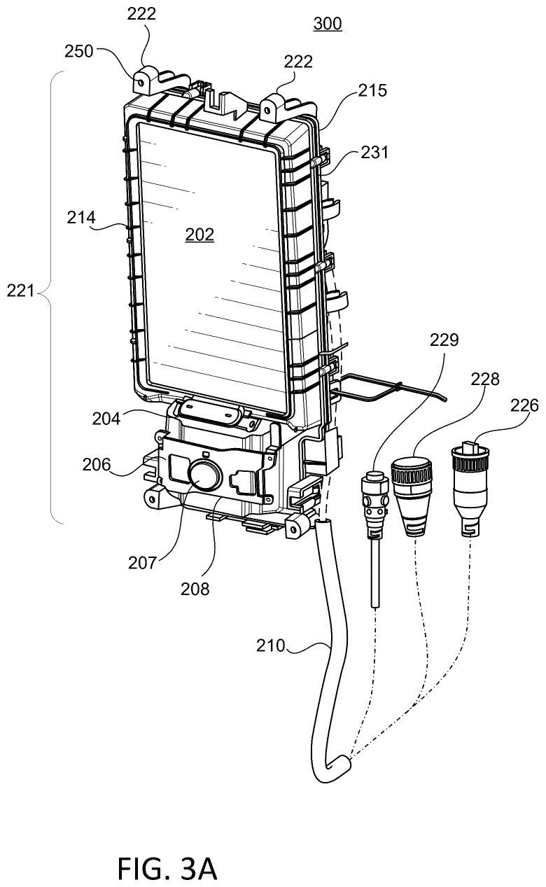

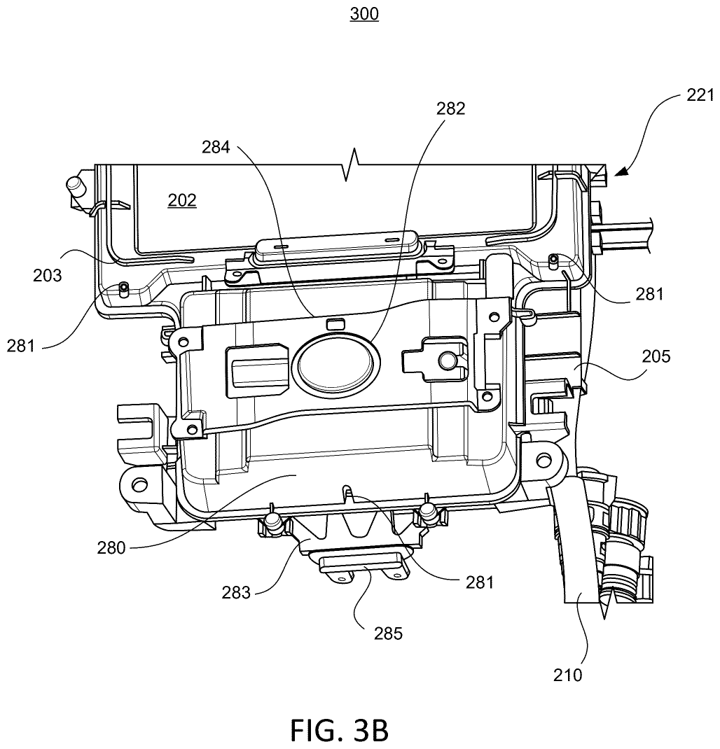

FIGS. 2A and 2B show perspective views of removable assemblies 200 of a vehicle charging system (e.g., vehicle charging system 100 of FIGS. 1A and 1B), in accordance with some embodiments of the present disclosure. For example, removable assemblies 200 include a modular display (e.g., display screen 202) and control circuitry (e.g., control circuitry 211), and a modular holster support (e.g., holster assembly 251), each of which may be a separate removable assembly or be coupled together as a single removable assembly. FIGS. 3A and 3B show perspective views of removable module 221 of FIGS. 2A and 2B, in accordance with some embodiments of the present disclosure. FIGS. 2A-3B refer to the following components:
housing screen opening 201;
display screen 202;
upper portion 203;
user input interface 204;
lower portion 205;
payment module 206;
tap to pay reader 207;
payment diffuser 208;
holster assembly 209;
electrical interface 210;
control circuitry 211;
button cable 212;
housing 213;
housing front 214;
housing back 215;
holster flange 220;
removable module 221;
panel attachment tab 222;
cable seal 223 (e.g., cable entry seal);
control circuitry, I/O circuitry 224;
circuitry access panel 225;
USB connector 226;
holster alignment feature 227;
HDMI connector 228;
power connector 229;
user input interface port 230;
seal 231 (e.g., housing seal);
housing attachment thru-hole 250;
holster assembly 251;
holster light source 280;
exit pathway 281;
payment light source 282;
holster light pipes 283;
diffuser 284; and
holster light pipe light output 285.

Removable assemblies 200 include removable module 221 and holster assembly 251. In some embodiments, holster assembly 251 is attached to removable module 221. In some embodiments, holster assembly 251 need not be attached to removable module 221. As illustrated, removable module 221 includes housing 213, display screen 202, user input interface 204, payment module 206, a light source, electrical interface 210, control circuitry 211, and input/output (I/O) circuitry 224. To illustrate, vehicle charging system 100 may include removable assemblies 200, which may be modular such that removable assemblies 200 may be installed, removed, replaced, serviced, or otherwise act as a unit that may be removed or installed. By designing removable assemblies 200 to be modular, it may be replaced, installed, or removed by disengaging connections, without a need to disassemble the rest of vehicle charging system 100 (e.g., other than removal of a removable panel in some embodiments).

As illustrated, housing 213 includes housing front 214 attached to housing back 215. In some embodiments, as visible in FIG. 2B, seal 231 is positioned between housing front 214 and housing back 215. As illustrated in FIG. 2A, housing front 214 forms housing screen opening 201 through which display screen 202 is visible (e.g., from outside vehicle charging system 100 of FIGS. 1A and 1B). In some embodiments, housing front 214 may include a transparent or semi-transparent portion instead of the opening. Display screen 202 may be any of coupled to, attached to, or held in place by housing 213. In some embodiments, a seal 231 is positioned between housing front 214 and display screen 202. In some implementations, seal 231 is positioned around housing screen opening 201.

User input interface 204 receives input for the vehicle charging system. In the embodiment depicted, display screen 202 is not a touch screen, user input interface 204 is a button to receive input from a user. In some embodiments, display screen 202 is a touch screen, and user input interface 204 includes a touch screen of display screen 202. The button is coupled to button cable 212 to attach to housing back 215 (e.g., via user input interface port 230 illustrated in FIG. 2B) and to communicate with control circuitry 211 of removable module 221. The button is removably attached to housing front 214 and its cable is removably attached to housing back 215 to allow the button to be replaced independent of the rest of removable module 221. In some embodiments, the button is attached to housing 213 with two fasteners.

In some embodiments, control circuitry 211 is configured to, based at least in part on an interaction with the button, provide power to a charging cable of the vehicle charging system. In some embodiments, an interaction with user input interface 204 includes the button being touched (e.g., capacitive touch button) or pressed down (e.g., push-button). In some implementations, the button is touched or pressed any one of once, a certain number of times, or in a pattern (e.g., with pauses in between touches or presses or with touching or pressing the button for different durations). In some embodiments, user input interface 204 may receive input in response to a graphical user interface (GUI) displayed on display screen 202. In some implementations, the GUI may instruct the user to interact with the button in any one the following scenarios: when the charging cable coupler (FIG. 1A) is attached to a vehicle, when control circuitry 211 is ready to process payment, when the charging cable coupler is inserted into holster assembly 209 (e.g., after charging a vehicle is complete). Cable seal 223 may be included and configured to seal cabling that enters housing back 215 (e.g., to interface to control circuitry 211).

In some embodiments, user input interface 204 may be configured to receive an input when initiating an interaction with the vehicle charging system. In some embodiments, an interaction with user input interface 204 causes control circuitry 211 to perform any one of transition the vehicle charging system out of a power saving state or mode (e.g., sleep or hibernate, to name a few examples), turn on display screen 202, or illuminate light sources of the vehicle charging system (e.g., payment light source 282 or holster light source 280 illustrated in FIG. 3B). In some embodiments, user input interface 204 receives input when the vehicle charging system is being serviced. In some embodiments, the interaction includes a particular pattern (e.g., touches or presses of the button) to initiate a service state or mode.

Payment module 206 includes tap to pay reader 207 to receive contactless payment, such as from a credit card, digital wallet, mobile wallet, or mobile payment application, or other suitable payment source. Diffuser 284 covers tap to pay reader 207 and is illuminated to indicate the location of tap to pay reader 207. In some embodiments, diffuser 284 is arranged next to or adjacent to the reader. In some embodiments, diffuser 284 surrounds the reader, or the reader surrounds diffuser 284. In some embodiments, tap to pay reader 207 comprises a diffuser (e.g., and diffuser 284 need not be included as a separate component). In some embodiments, payment module 206 is a self-contained module that has its own antenna and communicates with control circuitry 211 (e.g., using I/O circuitry). In some embodiments, payment module 206 communicates with circuitry of the vehicle charging system through a USB connection. In some embodiments, payment module 206 communicates with circuitry of the vehicle charging system to initialize or authorize the vehicle charging system to output power (e.g., through the vehicle charging cable in FIG. 1A).

Housing front 214 includes an upper portion 203 and a lower portion 205. Housing screen opening 201 is formed in the upper portion 203. User input interface 204, diffuser 284, and tap to pay reader 207 are attached or coupled to the lower portion 205.

Referring to FIGS. 2A and 2B, electrical interface 210 includes one or more interface cables (e.g., three interface cables, as illustrated) that are each coupled to removable module 221 at one end and to a respective interface connector at the other end. For example, the illustrated interface connectors include USB connector 226 for a USB cable that connects to control circuitry 211, HDMI connector 228 for an HDMI cable that provides a display signal for display screen 202, and power connector 229 for a power cable to provide power to removable module 221. In some embodiments, the USB cable is communicatively coupled to control circuitry 211 via I/O circuitry 224, which accepts inputs for control circuitry 211. In some embodiments, the power cable is electrically coupled to control circuitry 211 and control circuitry 211 controls power distribution to removable module 221. In some embodiments, the power cable is electrically coupled to power circuitry that may be controlled by control circuitry 211. As illustrated, the interface connectors are coupled to corresponding connectors of system cables of the vehicle charging system. In some embodiments, any one of the system cables are coupled to circuitry of the vehicle charging system. In some embodiments, the interface cables isolate functionality of removable module 221 to improve serviceability, for example. In some embodiments, greater or fewer interface cables may be used. In some embodiments, control circuitry 211 provides the display signal for display screen 202 and the electrical interface does not include the HDMI cable. In some implementations, the interface cables are part of one cable having one connector (e.g., a single, multi-pin connector).

Referring to FIG. 2B, the interface cables enter housing back 215 through cable seals 223. User input interface port 230 is attached to, or integrally formed with, housing back 215. As illustrated in FIG. 2B, user input interface port 230 includes a female connector that is configured to receive a male connector of a user input interface cable. The female connector is coupled to control circuitry 211 to allow the button to be communicatively coupled with control circuitry 211. In some embodiments, the interface cables connect to interface ports of housing back 215.

Control circuitry 211 and I/O circuitry 224 are housed inside housing 213. I/O circuitry 224 accepts inputs for control circuitry 211, such as from electrical interface 210. Housing back 215 includes a removable circuitry access panel 225 to provide access to inside housing 213, such as to control circuitry 211. In some embodiments, the circuitry access panel 225 is not present. In some embodiments, housing back 215 is removed from housing front 214 to access inside housing 213. In the depicted embodiment, housing back 215 includes four panel attachment tabs 222 positioned at different locations along the perimeter of housing 213. Panel attachment tabs 222 extend over a portion of the panel front and are used to secure or attach removable module 221 to the electric vehicle system. In some embodiments, fasteners secure or attach removable module 221 to a frame (e.g., frame in FIGS. 9A, 9C, 14B, and 17) of the vehicle charging system. In some embodiments, housing 213 is coupled to the vehicle charging system with six or less total fasteners, such as with four fasteners. In some embodiments, fasteners secure or attach removable module 221 to a removable panel (e.g., a second removable panel in FIGS. 1A, 5-7B, 13A, and 15-17) of the vehicle charging system.

Holster assembly 209 includes holster flange 220 to attach holster assembly 209 to the vehicle charging system, such as to the second removable panel. In some embodiments, fasteners are inserted in thru holes of holster flange 220. In some embodiments, holster flange 220 slides into a corresponding channel of the vehicle charging system. Holster assembly 209 includes two holster alignment features 227 to align holster assembly 209 to the frame. In some embodiments, holster alignment feature 227 includes a threaded insert to receive a fastener disposed through the frame and attach holster assembly 209 to the frame. In some embodiments, holster alignment feature 227 interlocks with a corresponding frame alignment feature. In some embodiments, holster alignment feature 227 forms friction fit with a corresponding frame alignment feature. In some embodiments, holster alignment features 227 include a cutout, recess, or hole configured to align to an extension of the frame configured to fit within holster alignment feature 227.

In some embodiments, although not illustrated in FIGS. 2A-3B, a vehicle charging system includes a heater. In some embodiments, control circuitry 211 controls the heater (e.g., an ohmic heater having a resistive element) to heat electrical components or connections that may be adversely affected by cold weather. In some embodiments, one or more of the light sources function as the heater. In some examples, the light sources include a high-powered LED that provides heating to surrounding areas or components.

In some embodiments, any one of display screen 202, user input interface 204, or payment module 206 include separate control circuitry and/or input/output circuitry that interfaces with control circuitry 211 of removable module 221 or circuitry of the vehicle charging system.

FIGS. 3A and 3B are schematic illustrations of removable module 221, in accordance with embodiments of the disclosure. FIG. 3A shows removable module 221 without holster assembly 209. Housing 213 is sealed to resist and dust water intrusion. Seals (e.g., using seal 231) are formed between the front and back housings and between display screen 202 and the front housing. For example, when removable assemblies 200 is removed from vehicle charging system 100, removable assemblies 200 may be further separated into removable module 221 and holster assembly 251.

Referring to FIG. 3B, housing 213 includes exit pathways 281 for pressure equalization, normalization of humidity, and drainage of condensation inside housing 213. Ribs or channels internal to housing 213 direct condensation away from electrical components inside the housing, such as control circuitry 211 and I/O circuitry 224. Exit pathways 281 are positioned at low points in housing 213. In the depicted embodiment, exit pathways 281 are at lower left and right corners (as shown on the page) of the upper portion 203 of removable module 221 and at a lower center of the lower portion 205 of removable module 221. Exit pathways 281 allow fluid to drain outside of the vehicle charging system, such as onto an exterior surface of the second removable panel.

Removable module 221 includes payment light source 282 to denote a location of tap to pay reader 207 (FIG. 2A). Payment light source 282 illuminates diffuser 284 that covers tap to pay reader 207 to indicate the location of tap to pay reader 207, such as discussed in relation to FIG. 2A. Returning to FIG. 3B, removable module 221 includes holster light pipes 283 to direct light emitted from holster light source 280, discussed in relation to FIGS. 2A and 2B, to another end to illuminate holster assembly 209. In the depicted embodiment, light is received or inputted at an input end of the light pipes and outputted at an output end of the light pipes. Holster light pipe light output 285 is attached to the output end of holster light pipes 283 and is further attached to holster assembly 209. In some embodiments, holster light pipe light output 185 includes diffuser 284. In some embodiments, holster light pipe light output 285 is part of holster assembly 209.

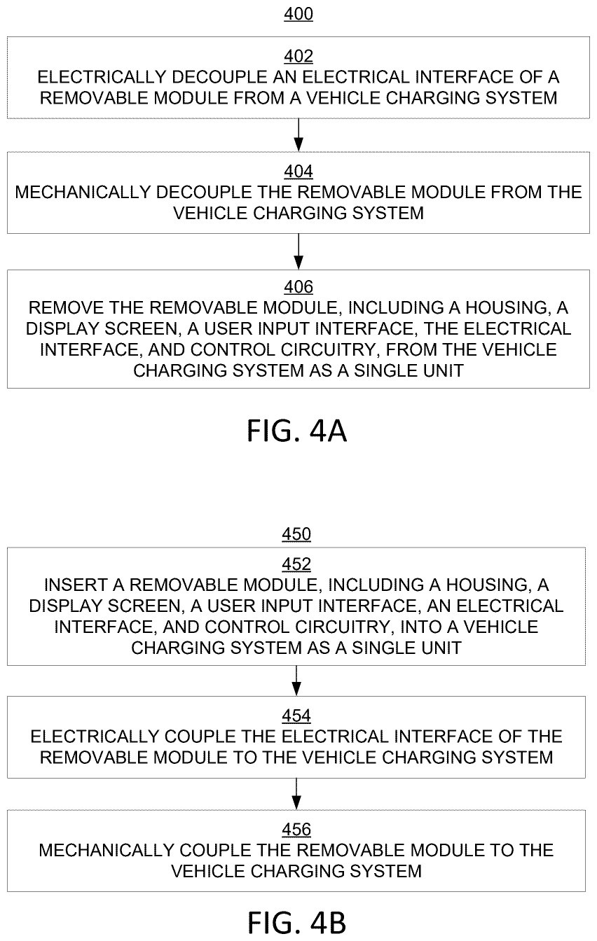

FIG. 4A is a flowchart of illustrative process 400 for removing a removable module (e.g., removable module in FIGS. 1A and 2A-3B) from a vehicle charging system (e.g., vehicle charging system in FIGS. 1A, 1B, 9A, and 11-13B), in accordance with embodiments of the disclosure.

Step 402 includes electrically decoupling an electrical interface of a removable module from a vehicle charging system, such as described in relation to FIGS. 2A and 2B. In some embodiments, the electrical interface includes interface cables having interface connectors. In some embodiments, electrically decoupling the removable module includes uncoupling interface cable connectors from system cable connectors. Step 402 may include disconnecting one or more connectors, or otherwise disengaging one or more electrical terminals between the removable module and the remaining assembly of the vehicle charging system.

Step 404 includes mechanically decoupling the removable module from the vehicle charging system, such as described above with respect to FIGS. 2A and 2B. In some embodiments, the removable module is mechanically decoupled from a frame (e.g., frame in FIGS. 9A, 9C, 14B, and 17) of the vehicle charging system. In some embodiments, the removable module is mechanically decoupled from a removable panel (e.g., second removable panel in FIGS. 1A, 5-7B, 13A, and 15-17) of the vehicle charging system. In some embodiments, mechanically decoupling the removable module includes any of removing fasteners or uncoupling cable connectors as discussed in relation to FIGS. 2A and 2B. Step 404 may include removing one or more fasteners, disengaging one or more securements (e.g., clips, friction interfaces, tabs, lips, or other suitable mechanical features for securing two components together), disengaging one or more aligning features, or a combination thereof.

Step 406 includes removing the removable module, including a housing, a display screen, a user input interface, the electrical interface, and control circuity, from the vehicle charging system as a single unit, such as described in relation to FIGS. 2A and 2B. Step 406 may include applying suitable force to move the removeable module away from the housing, checking that connections are disengaged, or both.

FIG. 4B is a flowchart of illustrative process 450 for installing a removable module (e.g., removable module in FIGS. 1A and 2A-3B) in a vehicle charging system (e.g., vehicle charging system in FIGS. 1A, 1B, 9A, and 11-13B), in accordance with embodiments of the disclosure.

Step 452 includes inserting a removable module into a vehicle charging system, such as described in relation to FIGS. 2A and 2B. In some embodiments, the removable module, includes a housing, a display screen, a user input interface, an electrical interface, and control circuity, and the removable module is inserted into the vehicle charging system as a single unit. Step 452 may include aligning features of the removable module to mating features or reference features of the vehicle charging system to ensure the arrangement of the removable module.

Step 454 includes electrically coupling the electrical interface of the removable module to the vehicle charging system, such as described in relation to FIGS. 2A and 2B. In some embodiments, the electrical interface includes interface cables having interface connectors. In some implementations, electrically coupling the removable module includes coupling interface cable connectors to system cable connectors. Step 454 may include connecting one or more electrical connectors, or otherwise engaging one or more electrical terminals between the removable module and the remaining assembly of the vehicle charging system.

Step 456 includes mechanically coupling the removable module to the vehicle charging system, such as described in relation to FIGS. 2A and 2B. In some embodiments, the removable module is mechanically coupled to a frame (e.g., frame in FIGS. 9A, 9C, 14B, and 17) of the vehicle charging system. In some embodiments, the removable module is mechanically coupled to a removable panel (e.g., second removable panel in FIGS. 1A, 5-7B, 13A, and 15-17) of the vehicle charging system. In some embodiments, mechanically coupling the removable module includes any of installing fasteners or coupling cable connectors as discussed in relation to FIGS. 2A and 2B.

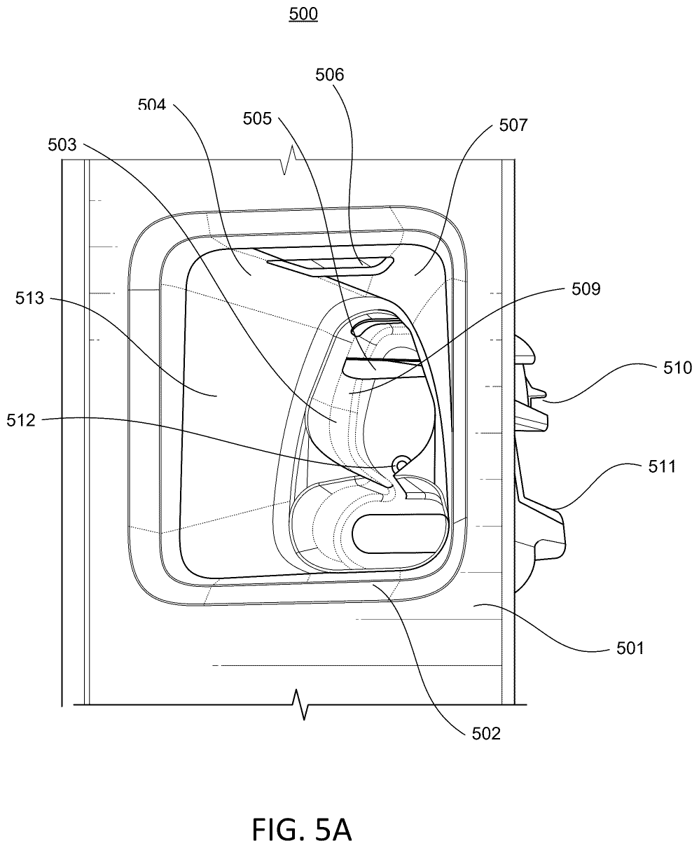

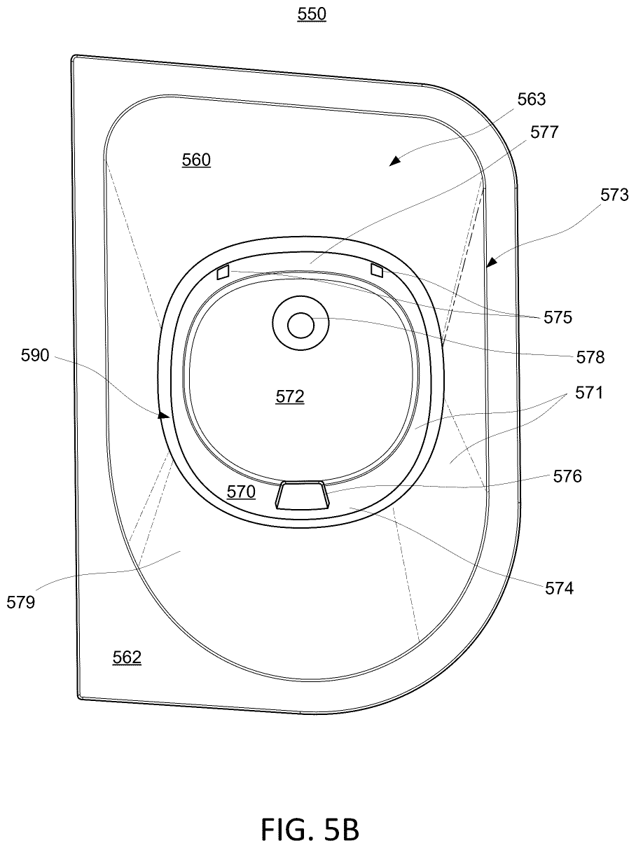

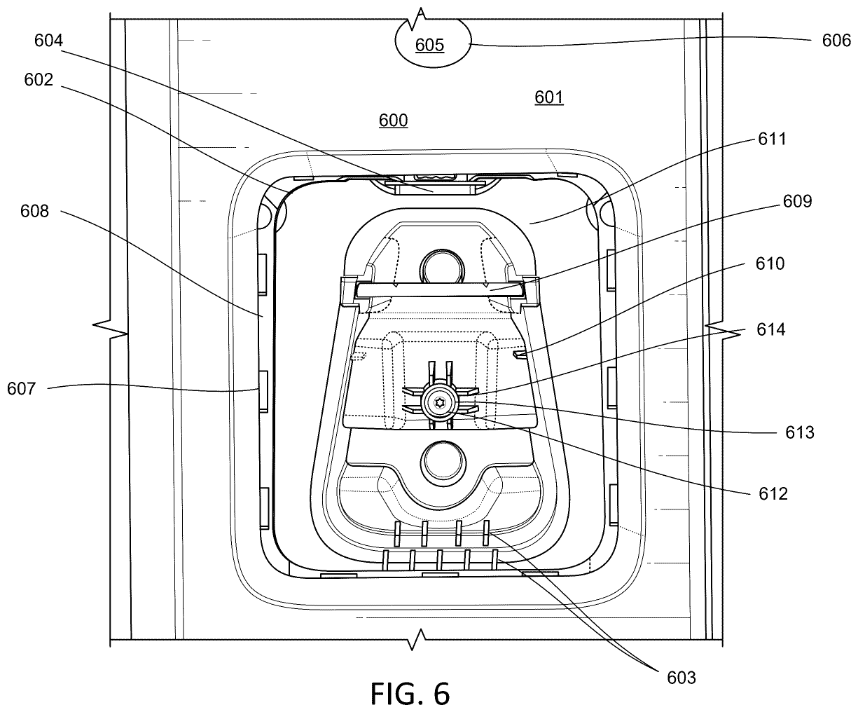

FIG. 5A is a schematic illustration of holster assembly 500, in accordance with embodiments of the disclosure. Holster assembly 500 includes holster skin 507, holster support 511 (e.g., having removable panel holster opening 502 to accommodate holster skin 507), and retention feature (e.g., pin in FIG. 6). In some embodiments, such as when the retention feature comprises a pin, holster skin 507 includes pin cover 505 and holster support attach point 512. Holster skin 507 forms holster skin cavity 504 to receive and stow the charging cable coupler (FIG. 1A) in the vehicle charging system. Holster skin cavity 504 has entry portion 513 and retaining portion 503. Entry portion 513 guides the charging cable coupler to retaining portion 503 and retaining portion 503 receives the coupler. Entry portion 513 includes light opening 506 to receive light from the holster light source (FIG. 3B). In some embodiments, light opening 506 is a thru-hole. In some implementations, light opening 506 receives the holster light pipe light output. In some examples, the holster light pipe light output is partially disposed in the thru hole of light opening 506. In some embodiments, light opening 506 comprises a transparent or semi-transparent material and light from the holster light pipe light output shines through the light opening. In some embodiments, the holster light pipe light output attaches to holster support 511 at a position corresponding to light opening 506 (e.g., in line with the light opening).

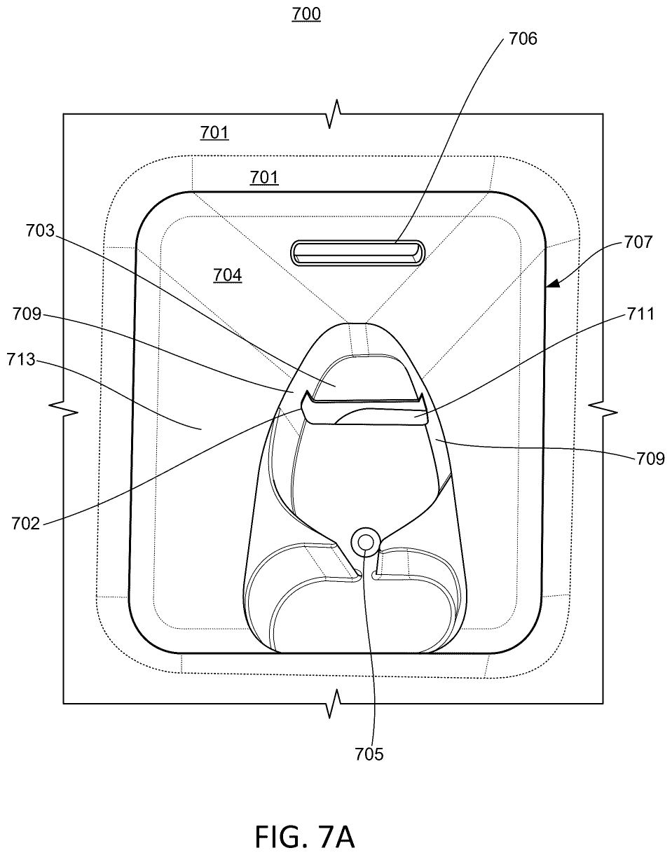

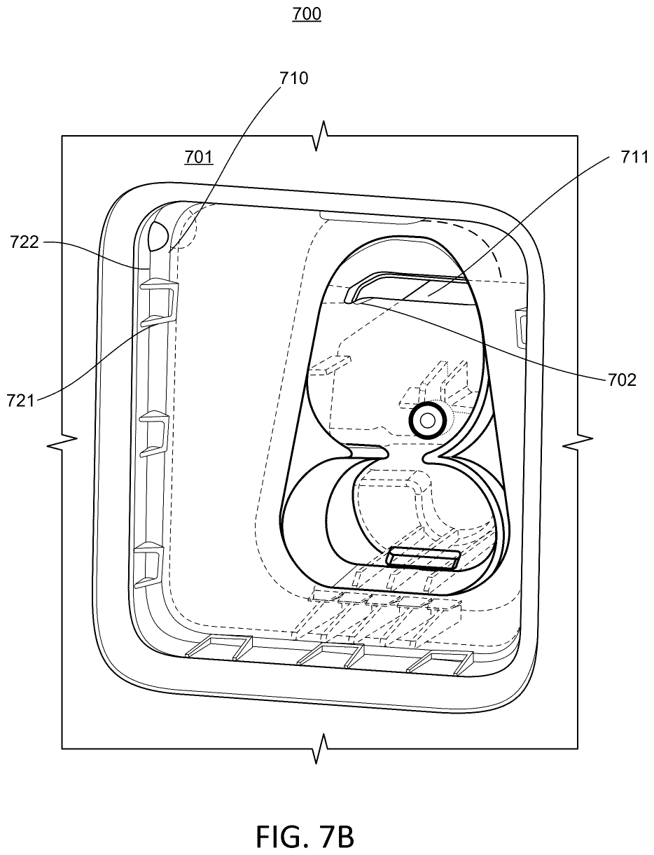

In some embodiments, the pin is coupled to holster support 511 and disposed between two sidewalls 509 of retaining portion 503 of the cavity. In some embodiments, pin cover 505 is located in retaining portion 503 of the cavity and between opposing sidewalls 509 of holster skin 507 (e.g., left and right sidewalls as shown on the page). Pin cover 505 covers at least a portion of the pin of holster assembly 500, such as a coupler retention pin. The pin retains the charging cable coupler in the cavity of holster skin 507. In some embodiments, the pin engages a retention feature of the charging cable coupler, such as a latch, to retain the coupler in the cavity of holster skin 507. In some implementations, the latch of the coupler engages pin cover 505 and underlying pin. In some implementations, the latch of the coupler engages the pin though an opening, cutout, recess, or indentation in pin cover 505. In some implementations, a button on the coupler is pressed to disengage the pin and remove the coupler from holster assembly 500. In some embodiments, pin cover 505 is part of the support structure or not present and opposing sidewalls 509 of holster skin 507 have a slot that receives pin cover 505 or pin as holster skin 507 is installed. In some embodiments, pin cover 505 is not included, such as discussed in relation to FIGS. 7A and 7B.

In some embodiments, the retention feature of the holster comprises a snap fit or snap fastener to engage a corresponding snap fit or snap fastener on the coupler. In some embodiments, the retention feature of the holster comprises one of a tab hook or loop to engage a corresponding loop of tab hook of the coupler. In some embodiments, the coupler comprises a release mechanism, such as a switch or button, to disengage the retention feature of the coupler from the retention feature of the holster.

Holster support attach point 512 attaches holster skin 507 to holster support 511. The holster attach point is positioned at a rear of holster skin 507 (e.g., at a bottom of the retaining portion of the cavity) and contains a thru-hole that receives a fastener to attach holster skin 507 to holster support 511. In some embodiments, the holster attach point contains a threaded insert. In some implementations, holster skin 507 may be detached and removed from holster support 511 by removing the fastener. As illustrated, holster support 511 includes holster alignment feature 510 configured to align holster skin 507 when installed.

A front of holster support 511 attaches to the vehicle charging system, such as to the second removable panel. In some embodiments, the holster flange (FIG. 2B) attaches holster support 511 to second removable panel 501. When the charging cable coupler is stowed in holster assembly 500, holster skin 507 is disposed between holster support 511 and the coupler. Holster support 511 provides structural support for holster assembly 500, such as by supporting a force exerted on holster assembly 500 by the charging cable coupler as discussed below in relation to FIG. 6. In some embodiments, holster skin 507 is formed as a single, unitary component. In some implementations, holster skin 507 may be formed by any of injection molding, machining, three-dimensional printing, etching, or any manufacturing technique known to one in the art.

FIG. 5B shows a front perspective view of holster skin 550, in accordance with embodiments of the disclosure. For example, holster skin 550 may be configured to alternatively be installed in a holster support (e.g., in place of holster skin 507) and configured to secure North American Charging System (NACS) type charging couplers. As illustrated, holster skin 550 does not include any moving parts such as a latch or mechanism. Holster skin 550 is configured to secure a charging coupler using features such as hook 576 and ribs 575. As illustrated, holster skin 550 includes a tapered recess having two sections (e.g., first section 310 and second section 570, joined by transition section 590). In some embodiments, transition section 590 is omitted (e.g., first section 560 is adjacent to second section 320, without any substantial transitioning). First section 310 is a lead in and is tapered (e.g., defining a tapered portion of recess 563) to direct a coupler into and out of holster skin 550. Second section 570 includes hook 576 and at least one rib (e.g., ribs 575) to hold the coupler. Lateral surface 571, which includes first and second sections 560 and 570 (e.g., extending around the top, bottom, and lateral sides) is continuous, without holes or otherwise openings. As illustrated, sidewall 579 includes end face 572, opposite the main opening (e.g., opening 573 through which the coupler is inserted and removed), may include a single hole (e.g., hole 578, which may be a through hole) for mounting holster skin 550 against a frame member (e.g., a structural member of the charger), holster support, or a combination thereof. Because this single hole (e.g., hole 578) may be sealed using a sealed fastener (e.g., a fastener with a gasket or compliant material, or a sealant), when installed, holster skin 550 is leakproof at end face 572 and lateral sides. Opposite end face 572 is flange 562, which is configured to interface with a wall of the charger (e.g., a planar face such as a side of the charger), such that holster skin 550 forms recess 563 into the wall to store the charging coupler. Opening 573 is defined by the meeting of flange 562 and lateral surface 571, and opening 573 is configured to accommodate the charging coupler into recess 563 (e.g., opening 573 allows the charging coupler to enter recess 563). In some embodiments, sidewall 579 includes flange 562 that surrounds opening 573 of the recess 563 and is configured to interface with a surface of a charger (e.g., vehicle charging system 100 of FIGS. 1A and 1B). For example, as illustrated, flange 562 extends outward from opening 573.

First section 560, second section 570, and transition section 590 of lateral surface 571 form recess 563, which tapers from opening 573 of recess 563 to end face 572. Hook 576 and ribs 575 are configured to engage the charging coupler (e.g., surfaces or features thereof) to secure the coupler in recess 563 while allowing it to be de-docked along a trajectory. For example, a charging coupler may be removable from second section 570 by lifting the charging coupler over hook 576 and moving the charging coupler out of the second section past the at least one rib (e.g., ribs 575). In some embodiments, as illustrated, hook 576 and ribs 575 protrude from sidewall 579 into recess 563. Sidewall 579 refers to the totality of the solid body of holster skin 550, except for hook 576, ribs 575, and any holes, recesses, or volumes (e.g., sidewall 579 includes only the holster material forming the walls, end face 572, and flange 562). Lateral surface 571 of sidewall 579 defines recess 563. First section 560 defines a tapered portion of recess 563 configured to accommodate a charging coupler, and hook 576 and the at least one rib (e.g., ribs 575) extend from second section 570 into recess 563 to hold the charging coupler in the recess. As illustrated, hook 576 is arranged opposite to at least one rib (e.g., ribs 575). For example, hook 576 may be arranged at a bottom of second section 570 (e.g., bottom section 574), and the at least one rib (e.g., ribs 575) is arranged at a top of second section 570 (e.g., top section 577).

In some embodiments, holster skin 550 is one-piece, formed from a single piece of material (e.g., using a molding process). For example, because holster skin 550 may be a single piece, its construction is relatively simple and there are no seams or interfaces to loosen or leak. In a further example, first section 560 and second section 570 (e.g., and transition section 590, if included) are continuous and without holes or openings such that lateral surface 571 is leakproof. In some embodiments, for example, sidewall 579, hook 576, and the at least one rib (e.g., ribs 575) are a continuous piece of material formed using a mold. In a further example, aside from hole 578 which may itself be sealed when installed, there are no openings, holes, or through intrusions in sidewall 579. Accordingly, holster skin 550 may be installed in a vehicle charging system, and no other connections or intrusions need be made into recess 563 (e.g., other than docking a charging coupler through opening 573).

FIG. 6 is a schematic cutaway illustration of holster assembly 600, in accordance with embodiments of the disclosure. As illustrated in FIG. 6, holster support 611 is attached to second removable panel 601 without the holster skin. As illustrated, holster assembly 600 includes removable panel holster opening 602, support rib 603, holster light pipe light output 604, tap to pay reader 605, removable panel reader opening 606, removable panel holster slot 607 (e.g., configured to mate with a tab on holster skin), removable panel holster flange 608, retention feature 609 (e.g. pin, coupler retention pin), locator rib 610, holster support 611, fastener 612, threaded insert 613, and fastener support structure 614.

In some embodiments, holster support 611 includes support ribs 603, locator ribs 610, and fastener support structure 614. Fastener support structure 614 and the holster attach point (FIG. 5) are used together to attach the holster skin to holster support 611. Fastener support structure 614 is positioned at a rear of holster support 611 and contains threaded insert 613 to receive fastener 612 disposed in the thru hole of the holster attach point. Support ribs 603 support the force exerted on the holster assembly by the charging cable coupler, such as from a user inserting the coupler into the holster assembly or from a weight of the retained coupler. In some embodiments, support ribs 603 support a force (e.g., at least a portion of the weight) of the coupler when the coupler is retained by the holster assembly. The depicted embodiment has two sets of support ribs 603 (e.g., arranged in two rows). Each rib of support ribs 603 extends in a direction from a front of the support structure to a rear of the support structure (e.g., from the flange to fastener support structure 614). The first set of support ribs 603 is near the front of the support structure and, when the holster skin is installed, positioned to support force from the coupler in the entry portion of the skin cover. The second set of support ribs 603 is near the rear of the support structure and positioned to support force from the coupler in the retaining portion of the skin cover.

Locator ribs 610 are positioned at left and right sides of holster support 611 and support side to side motion of the coupler in the holster assembly. In some embodiments, locator ribs 610 limit movement of the coupler in a vertical or longitudinal direction (as shown on the page) and permit movement of the coupler in a horizontal or lateral direction (e.g., to help secure the coupler when docked). In the embodiment depicted in FIG. 6, retention feature 609 includes a pin configured to break or sheer when a load applied exceeds a load threshold. In some embodiments, the load threshold is 60% or less of the load at which a latch of the charging cable coupler is designed to break, or 45% or less, or 40% or less, or 30% or less, or 25% or less. In such embodiments, the pin breaks before the charging cable coupler. The broken pin may be removed, and a replacement pin installed. This may be easier and cheaper than replacing or repairing a broken latch of the charging cable coupler. In some embodiments, the pin includes notches to break the pin at the load threshold. In some embodiments, the pin has a thickness that breaks the pin at the load threshold.

Second removable panel 601, which may be the same as second removable panel 102 of FIGS. 1A and 1B, includes removable panel holster flange 608 at a perimeter of removable panel holster opening 602. The holster skin is attached to second removable panel 601 by inserting holster skin tabs (see, e.g., FIG. 7) into removable panel holster slots 607 formed in removable panel holster flange 608.

FIG. 7A is a schematic illustration of holster skin 707 of a holster assembly, in accordance with embodiments of the disclosure. FIG. 7B is a partially transparent illustration of the holster assembly in FIG. 7A, in accordance with embodiments of the disclosure. FIGS. 7A and 7B are herein described together for brevity. As illustrated, holster skin 707 is attached to second removable panel 701, and includes pin cutout 702, retaining portion 703, holster skin cavity 704, fastener 705, light opening 706, holster skin 707, sidewall 709, removable panel holster opening 710, holster support 711, holster skin rim 712, entry portion 713, holster skin tab 714, holster skin tab 721, and holster skin rim 722. For example, holster skin 707 may be configured to be attached to, and removed from, holster support 611 of FIG. 6 (e.g., as illustrated, holster skin 707 is arranged in front of, and substantially blocks from view, holster support 611 in FIGS. 7A and 7B).

Referring to FIG. 7A, the holster assembly includes holster skin 707, holster support 711 (e.g., arranged behind holster skin 707, as illustrated), and a pin (not shown). Holster skin 707 forms light opening 706. Holster skin 707 also forms pin cutout 702 or a slot to receive and/or accommodate the pin of the holster assembly (e.g., pin in FIG. 6). In some embodiments, opposing sidewalls 709 of holster skin 707 form at least a portion of pin cutout 702. In some implementations, a rear of holster skin 707 (e.g., at a bottom of the retaining portion of the cavity) form at least a portion of pin cutout 702. In some embodiments, the pin enters pin cutout 702 when holster skin 707 is installed in the holster assembly. In some embodiments, holster skin 707 includes a seal between pin cutout 702 and the pin to prevent water or dust from contacting holster support 711. In some implementations, the seal includes any of a gasket material or bristles.

Referring to FIG. 7B, holster skin 707 is shown as partially transparent. Holster skin 707 includes holster skin rim 712 at the entryway. When holster skin 707 is installed in the vehicle charging system, entry portion 713 of holster skin cavity 704 blocks holster skin rim 712 from view. Holster skin tabs 714 are located in holster skin rim 712. In the depicted embodiment, there are three holster skin tabs 714 in each of a left, right, and lower side of holster skin rim 712. Holster skin tabs 714 attach to respective the removable panel holster slots (FIG. 6). In some embodiments, the tabs include a protrusion that catches a lip of the slots. In some implementations, holster skin 707 is detached from the removable panel by pressing on the tabs (e.g., towards the removable panel) to disengage the protrusion of the tab from the lip of the slot.

In some embodiments, holster skin 707 is arranged such that holster skin cavity 704 (FIGS. 5 and 7A) at least partially passes through removable panel holster opening 710 (FIGS. 5 and 7A) and a charging cable coupler (FIG. 1A) extends through the opening when the coupler is retained in the cavity. In some implementations, holster skin rim 712 and corresponding portion of entry portion 713 of the cavity (FIGS. 5 and 7A) are disposed on one side (e.g., an outer side) of removable panel holster opening 710 and the rest of the cavity is disposed the other side (e.g., an inner side) of removable panel holster opening 710.

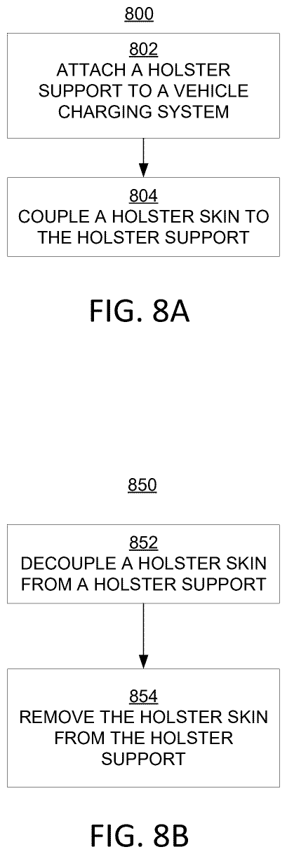

FIG. 8A is a flowchart of illustrative process 800 for installing a holster skin (e.g., holster skin in FIGS. 5-7B) in a vehicle charging system (e.g., vehicle charging system in FIGS. 1A, 1B, 9A, and 11-13B), in accordance with embodiments of the disclosure.

Step 802 includes attaching a holster support (e.g., holster support in FIGS. 5-8) to the vehicle charging system. In some embodiments, the holster support is attached to at least one of a removable panel (e.g., second removable panel in FIGS. 1A, 5-7B, 13A, and 15-17), a frame (e.g., frame in FIGS. 9A, 9C, 14B, and 17), or a removable module (e.g., removable module in FIGS. 1A and 2A-3B) of the vehicle charging system. To illustrate, step 802 may include installation of removable assemblies 200 of FIGS. 2A and 2B, which may include a holster support.

Step 804 includes coupling the holster skin to the holster support. In some embodiments, the holster skin forms a cavity to receive a charging cable coupler (e.g., charging cable coupler in FIG. 1A), such as discussed in relation to FIG. 5. In some implementations, a fastener couples the holster skin to the holster support. In some examples, the fastener engages a holster attach point positioned at a rear of the holster skin to attach the holster skin to the holster support, such as discussed in relation to FIG. 5.

In some embodiments, the holster skin includes a pin cover within the cavity to cover a pin and the pin is configured to retain the coupler in the cavity of the holster skin, such as described in relation to FIG. 5. In some embodiments, the holster skin includes a pin cutout within the cavity to receive the pin, such as described in relation to FIGS. 7A and 7B.

In some embodiments, the process continues with attaching the holster skin to the vehicle charging system. In some embodiments, the holster skin is attached to the removable panel such that the cavity of the holster skin at least partially passes through an opening in the removable panel (e.g., removable panel holster opening in FIGS. 5, 6, and 7B). In some embodiments, the coupler extends through the opening when the coupler is retained in the cavity. In some embodiments, a tab of the holster skin (e.g., holster skin tab in FIG. 7B) is inserted into a slot of the removable panel (e.g., removable panel holster slot in FIG. 6).

In some embodiments, such as where the holster support attaches to the removable panel, the process continues with attaching the removable panel to the vehicle charging system.

FIG. 8B is a flowchart of illustrative process 850 for removing a holster skin (e.g., holster skin in FIGS. 5-7B) from a vehicle charging system (e.g., vehicle charging system in FIGS. 1A, 1B, 9A, and 11-13B), in accordance with embodiments of the disclosure.

Step 852 includes decoupling the holster skin from a holster support (e.g., holster support in FIGS. 5-8). In some embodiments, a fastener couples the holster skin to the holster support, such as discussed in relation to FIG. 5. In some implementations, the fastener is removed to decouple the holster skin from the holster support. The process continues with removing the holster skin from the holster support.

Step 854 detaching the holster skin from the vehicle charging system. In some embodiments, the holster skin is detached from at least one of a removable panel (e.g., second removable panel in FIGS. 1A, 5-7B, 13A, and 15-17), a frame (e.g., frame in FIGS. 9A, 9C, 14B, and 17), or a removable module (e.g., removable module in FIGS. 1A and 2A-3B) of the vehicle charging system. In some embodiments, a tab of the holster skin (e.g., holster skin tab in FIG. 7B) is removed from a slot of the removable panel (e.g., removable panel holster slot in FIG. 6).

FIGS. 9A-9C are schematic illustrations of a portion of vehicle charging system 900, including one or more tray assemblies, in accordance with embodiments of the disclosure. FIGS. 9A-9C are herein described together for brevity. For example, vehicle charging system 900 may be similar to 100 of FIGS. 1A and 1B, and may include one or more modular tray assemblies (e.g., high-voltage tray assembly 904 and low-voltage tray assembly 919), which may be removed, installed, replaced, or otherwise managed separately from the rest of the vehicle charging system. For example, vehicle charging system 900 may include one or more removable trays that are configured to be removed or installed without disassembling significant portions of the rest of the system.

Referring to FIG. 9A, high-voltage tray assembly 904 and low-voltage tray assembly 919 are shown. The high-voltage tray assembly 904 includes a high-voltage tray 903, rigid busbar 905 and rigid busbar 913, and electrical components. High-voltage tray 903 has a plurality of slots 909 for removably mounting the high-voltage tray 903 to vehicle charging system 900. In some embodiments, high-voltage tray 903 is mounted to frame 917. In some implementations, the portion of frame 917 to which high-voltage tray 903 is mounted is sealed to prevent water intrusion. In some implementations, cables of vehicle charging cable 916 enter the sealed portion of the frame through cable gland 945 that prevents water from entering. In some embodiments, high-voltage tray 903 is mounted to electronics cabinet 918 inside vehicle charging system 900. In some implementations, electronics cabinet 918 is attached to frame 917. In some implementations, electronics cabinet 918 is sealed to prevent water intrusion. The electrical components are attached to high-voltage tray 903 and include high-voltage electrical components 902 (e.g., a contactor, filter, inductor, capacitor, or other suitable component), such as high-voltage direct current components. Rigid busbars 905 and 913 distribute electricity between high-voltage electrical components 902 and receive and/or output high-voltage electricity from or to components or systems external to high-voltage tray 903. In the embodiment depicted in FIG. 9A, output rigid busbar 905 is removably coupled to vehicle charging cable 916 for vehicle charging system 900. In an illustrative example, high-voltage tray assembly 904 may include rigid busbars 905 and 913, along with any other suitable busbars, which may allow shorter cable lengths to be used, while providing a modular assembly that may be removed or installed. As illustrated, vehicle charging system 900 includes removable module 901.

The plurality of slots 909 are used to position high-voltage tray assembly 904 inside vehicle charging system 900. Referring to FIGS. 9A and 9C, high-voltage tray 903 is a unitary body that includes two sides angled to one another. In some embodiments, high-voltage tray 903 has at least two slots 909 configured to removably mount high-voltage tray 903 assembly to two walls of vehicle charging system 900. In some implementations, first side 961 of high-voltage tray 903 mounts to first wall 911 of frame 917 and second side 962 of the tray mounts to second wall 912 of the frame 917. In some embodiments, first wall 911 is adjacent to and/or parallel with the first removable panel (FIGS. 1A, 13A, 13B, 14A, and 15-17) and second wall 912 is adjacent to and/or parallel with the second removable panel (FIGS. 1A, 5-7, 13A, and 15-17).

High-voltage tray 903 includes two slots 909 on first side 961 and two slots 909 on second side 962. As illustrated in the enlargements of region 995, fastener 908 is positioned in each slot 909 to engage high-voltage tray 903 with vehicle charging system 900.

Slots 909 on first side 961 are t-shaped slots and slots 965 on second side 962 are a straight channel slots. The t-shaped slots 909 are formed by two straight channels that intersect to form a capital “T” letter. The straight channels are angled to one another. In the depicted embodiment, the straight channels are angled at 90 degrees and run horizontal and vertical. In some embodiments, a different angle may be used such as 85-90°, 80-90°, 70-90°, or 45-90°. The horizontal straight channel provides first region 922 or leg to guide movement of high-voltage tray 903 in a first direction and the vertical straight channel provides second region 923 or leg to guide movement of high-voltage tray 903 in a second direction. Straight channel slots 965 on second side 962 are vertical slots. In some embodiments, vertical slots 965 are parallel to the vertical straight channel of t-shaped slots 909. When fasteners 964 are positioned in straight channel slots 965 and the vertical straight channel of t-shaped slots 909, fasteners 964 guide movement of high-voltage tray 903 to a position for output rigid busbar 905 to couple to vehicle charging cable 916. In some embodiments, the electronics components include terminal block 906 having screw terminals to electrically couple and decouple output rigid busbar 905 to the charging cable.

Referring to FIG. 9B, high-voltage tray 903 includes tray ground patch 951. In some implementations, high-voltage tray 903 is painted, and tray ground patch 951 is a bare metal (e.g., non-painted) portion of high-voltage tray 903. In some embodiments, tray ground patch 951 is a conductive material that directly contacts or is bonded to high-voltage tray 903. Tray ground patch 951 is electrically coupled to frame ground patch 924 (see enlargements of region 995 in FIG. 9A) of frame 917 such that high-voltage tray 903 is grounded to frame 917. In some embodiments, the electrical components of high-voltage tray 903 are grounded to high-voltage tray 903. Frame ground patch 924 may be a bare metal portion of frame 917 or a conductive material.

In some embodiments, the electrical components only include electrical components 914 for handling high voltage. In some implementations, placement of high-voltage electronic components 914 on high-voltage tray 903 requires tight tolerances to prevent heat buildup, arcing, sparks, insulation breakdown, contact fretting, and material deterioration. Attaching high-voltage electrical components 914 to a single, removable tray allows manufacture and/or assembly of high-voltage tray 903 assembly and high-voltage electronic components 914 outside of vehicle charging system 900.

In some embodiments, the cables of vehicle charging cable 916 are liquid cooled and include an end terminal to electrically couple to the output busbar. In some implementations, the terminal attaches to the terminal block 906. The liquid-cooled cables may not be flexible enough to be moved or bent, or may risk being damaged when moved or bent. High-voltage tray assembly 904 allows high-voltage tray 903 and terminal block 906 to be moved to the liquid-cooled cables for an easier and less risky installation than one where the cables are moved.

Referring to FIG. 9A, low-voltage tray assembly 919 includes low-voltage tray 920 and electrical components. The low-voltage tray mounts to the vehicle charging system using a plurality of slots, such as discussed below in relation to FIG. 11. The electrical components include low-voltage components, such as low-voltage direct current components. In some embodiments, the low-voltage electrical components only include electrical components 921 for handling low-voltage. In some implementations, high-voltage tray assembly 904 and low-voltage tray assembly 919 isolate high and low voltage electrical components, and allow any of the high or low voltage electrical components to be easily removed from vehicle charging system 900.

FIG. 10 shows a perspective view of portion 998 of high-voltage tray assembly 904, in accordance with embodiments of the disclosure. In particular, FIG. 10 shows cables 1004 of the liquid-cooled charging cable connected to terminal block 906 (e.g., mounted to second side 962) of high-voltage tray assembly 1001. End terminal 1005 of each charging cable is attached to terminal block 906 using screw terminals 1007. The slots of high-voltage tray 903 allow terminal block 906 to move end terminals 1005.

FIG. 11 shows a perspective view of portion 999 of vehicle charging system 900, including tray assemblies (e.g., low-voltage tray assembly 919 and high-voltage tray assembly 904, in accordance with embodiments of the disclosure.

Low-voltage tray assembly 919 includes tray 1105, which may be a sheet metal structure or otherwise a thin-walled structure configured to receive mounted electrical components (e.g., such as electrical component 925) and interface to a vehicle charging system. Low-voltage tray assembly 919 also includes slots 1102. As illustrated in FIG. 11, slots 1102 include two straight channel slots 1102 to guide movement of the tray in a single direction. In some embodiments, straight channel slots are horizonal slots 1102 that allow the tray to move horizontal (e.g., left and right as shown on the page). Low-voltage tray assembly 919 is configured to mount to first wall 1103 and straight channel slots 1102 guide the tray to be mounted to third wall 1104 opposite of second wall 912.

In some embodiments, high-voltage components are components that require or operate at high voltage. Low-voltage components are components that require or operate at low voltage. In some embodiments, high voltage refers to a voltage level above 1,000 V and low voltage refers to a voltage level at or below 1,000 V. In some embodiments, high voltage refers to a voltage level at or above 1,000 V and/or low voltage refers to a voltage level at or below 50 V. In some embodiments, high voltage refers to a voltage level at or above 35,000 V and/or low voltage refers to a voltage level at or below 600 V.

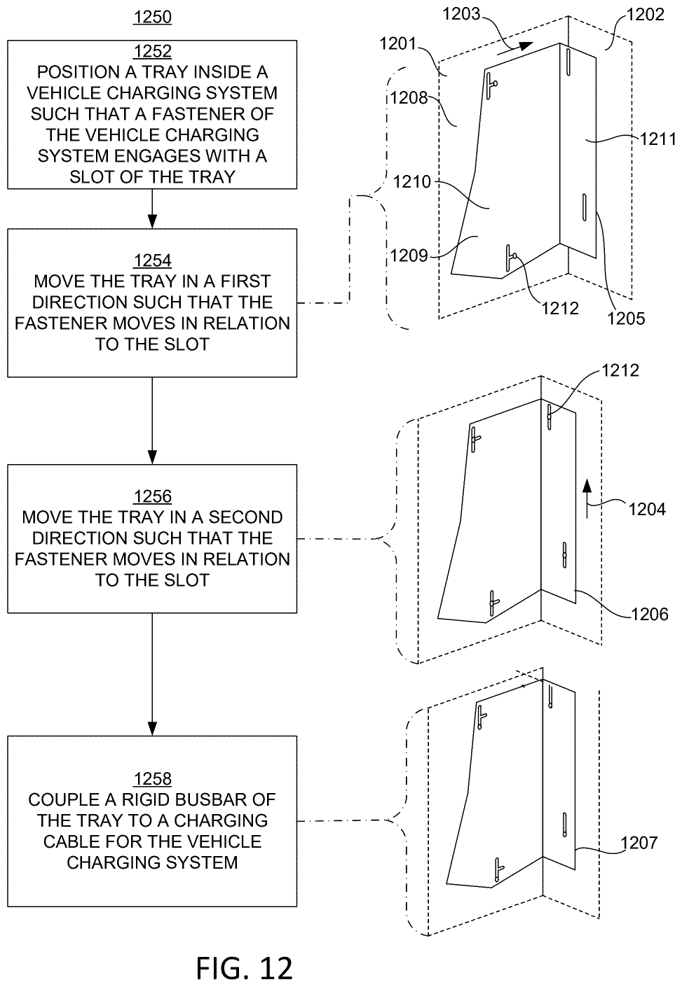

FIG. 12 is a flowchart of illustrative process 1250 for installing tray 1209 (e.g., tray in FIGS. 9A-11) of electrical components (e.g., electrical components and terminal block in FIGS. 9A, 9C, and 10) in a vehicle charging system (e.g., vehicle charging system in FIGS. 1A, 1B, 9A, and 11-13B), in accordance with embodiments of the disclosure. To illustrate, process 1250 may include installing a modular tray assembly into a vehicle charging system, and process 1250 may be reversed to govern removing the modular tray assembly. Accordingly, a vehicle charging system may include one or more tray assemblies (e.g., a low-voltage tray assembly, high-voltage tray assembly, any other suitable modular assembly, or any combination thereof).

Step 1252 includes positioning tray 1209 inside the vehicle charging system such that fastener 1212 of the vehicle charging system engages with a slot of tray 1209, such as discussed in relation to FIG. 9A. In some embodiments, fastener 1212 engages the slot when tray 1209 is in first position 1205 and fastener 1212 is positioned in a first region of the slot.

Step 1254 includes moving tray 1209 in first direction 1203 such that fastener 1212 moves in relation to the slot. In some embodiments, tray 1209 moves in first direction 1203 by using a first region of a t-shaped slot to guide movement of tray 1209 from first position 1205 to intermediate position 1206. In some embodiments, first direction 1203 is a horizontal direction.

Step 1256 includes moving tray 1209 in second direction 1204 such that fastener 1212 moves in relation to the slot. In some embodiments, tray 1209 moves in second direction 1204 by using a second region of the t-shaped slot to guide movement of tray 1209 from intermediate position 1206 to second position 1207. In some embodiments, second direction 1204 is angled with respect to first direction 1203. In some implementations, second direction 1204 is a vertical direction.

Step 1258 includes coupling a rigid busbar (e.g., rigid busbar in FIGS. 9A and 10) of tray 1209 to a charging cable (e.g., charging cable in FIGS. 1A and 1B and/or cables connected to charging cable in FIGS. 9A and 10) for the vehicle charging system. In some embodiments, the rigid busbar is coupled to the charging cable when tray 1209 is in second position 1207 and fastener 1212 is positioned in a second region of the slot. In some embodiments, each of the rigid busbar and the charging cable are attached to a terminal block. In an illustrative example, process 1250 may be applied to install and connect high-voltage tray assembly 904 of FIG. 9A.

FIGS. 13A and 13B show perspective views of a vehicle charging system 1300 (e.g., which may be the same as vehicle charging system 100 of FIGS. 1A and 1B), in accordance with embodiments of the disclosure. FIGS. 13A and 13B are herein described together for brevity.

Vehicle charging system 1300 includes first removable panel 1301 (e.g., a front panel), second removable panel 1302 (e.g., an HMI panel), third removable panel 1303, fourth removable panel 1304, fifth removable panel 1305, and sixth removable panel 1306. Together with the system door, system lower panel, and roof (FIGS. 1A and 1B), the first through sixth removable panels form the exterior of the vehicle charging system and surround or encase the frame (FIGS. 9A, 9C, 14B, and 17).

The first through third removable panels are positioned above the fourth through sixth removable panels. The fourth through sixth removable panels may be referred to as lower panels. First removable panel 1301 is attached to the second, third, and fourth removable panels. Second removable panel 1302 is attached to the first and fifth removable panels. Third removable panel 1303 is attached to the first and sixth removable panels. Fourth removable panel 1304 is attached to the first, fifth, and sixth removable panels. Fifth removable panel 1305 is attached to the second and fourth removable panels. Sixth removable panel 1306 is attached to the third and fourth removable panels.

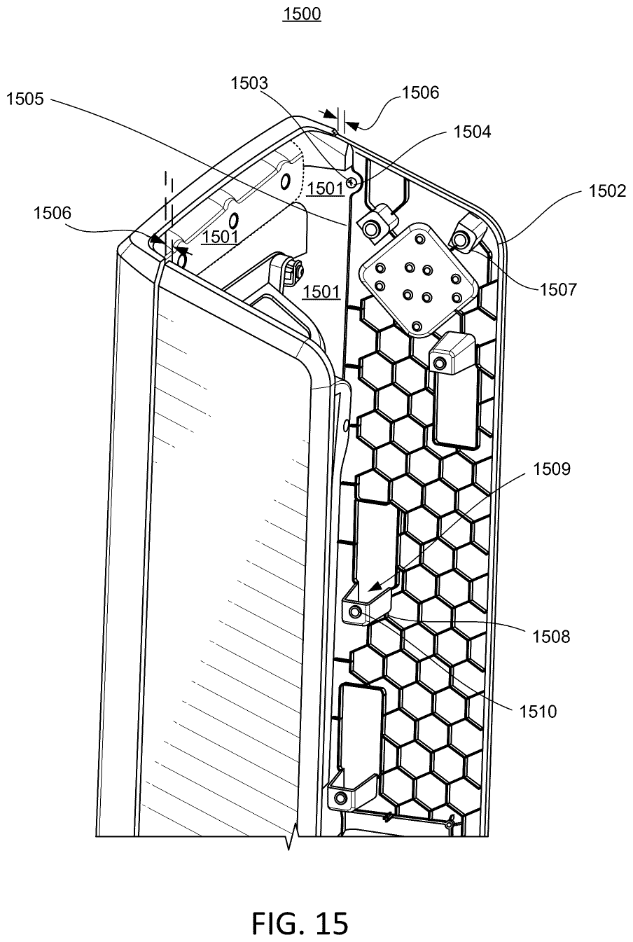

FIG. 14A is a schematic illustration of removable panels, in accordance with embodiments of the disclosure. FIG. 14B shows illustrative alignment features of a frame, in accordance with embodiments of the disclosure. The alignment features of FIG. 14B may be used to maintain spacing or gaps (FIG. 15) between the removable panels of FIG. 14A, for example. FIGS. 14A and 14B are herein described together for brevity.

Referring to FIG. 14A, first removable panel 1401 includes fifth alignment feature 1407, seventh alignment feature 1408, frame attachment holes 1403, charging cable holder 1404, and first panel lower flange 1402. In some embodiments, fifth alignment feature 1407 is any one of a hole or a four-way locator. In some embodiments, seventh alignment feature 1408 is any one of a slot, vertical slot, or two-way locator.

As illustrated in FIG. 14A, charging cable holder 1404 is attached to first removable panel 1401 and includes cable opening 1405 for the vehicle charging cable to enter the inside of the vehicle charging system. In some embodiments, a cable entry seal is disposed between cable opening 1405 and the charging cable. As illustrated in panel 1497 of FIG. 14B, which shows an interface region of first removable panel 1401 and fourth removable panel 1406, first panel lower flange 1402 includes ninth alignment feature 1409, eleventh alignment feature 1411, and thirteenth alignment feature 1413. In some embodiments, respective ninth, eleventh, and thirteenth alignment features 1409, 1411, and 1413 are slots. In the depicted embodiment, ninth, eleventh, and thirteenth alignment features 1409, 1411, and 1413 are horizontal, vertical, and horizontal slots, respectively. For example, ninth, eleventh, and thirteenth alignment features 1409, 1411, and 1413 engage with tenth, twelfth, and fourteenth alignment features 1410, 1412, and 1414, respectively, of fourth removable panel 1406. In some embodiments, tenth, twelfth, and fourteenth alignment features 1410, 1412, and 1414 include pins, having suitable cross-sectional shape, length, taper, or other attributes.

Referring to FIG. 14B, frame 1415 includes sixth alignment feature 1416 (e.g., as illustrated in panel 1498) and eighth alignment feature 1417 (e.g., as illustrated in panel 1499). In some embodiments, sixth alignment feature 1416 is any one of a pin, stud, or mushroom-head fastener. In some embodiments, eighth alignment feature 1417 is a pin. Referring to FIGS. 14A and 14B, sixth alignment feature 1416 engages (e.g., is inserted into) fifth alignment feature 1407 to couple first removable panel 1401 to frame 1415. Eighth alignment feature 1417 engages (e.g., is inserted into) seventh alignment feature 1408 to further constrain movement and provide support such that first removable panel 1401 is attached to frame 1415 using frame attachment holes 1403.

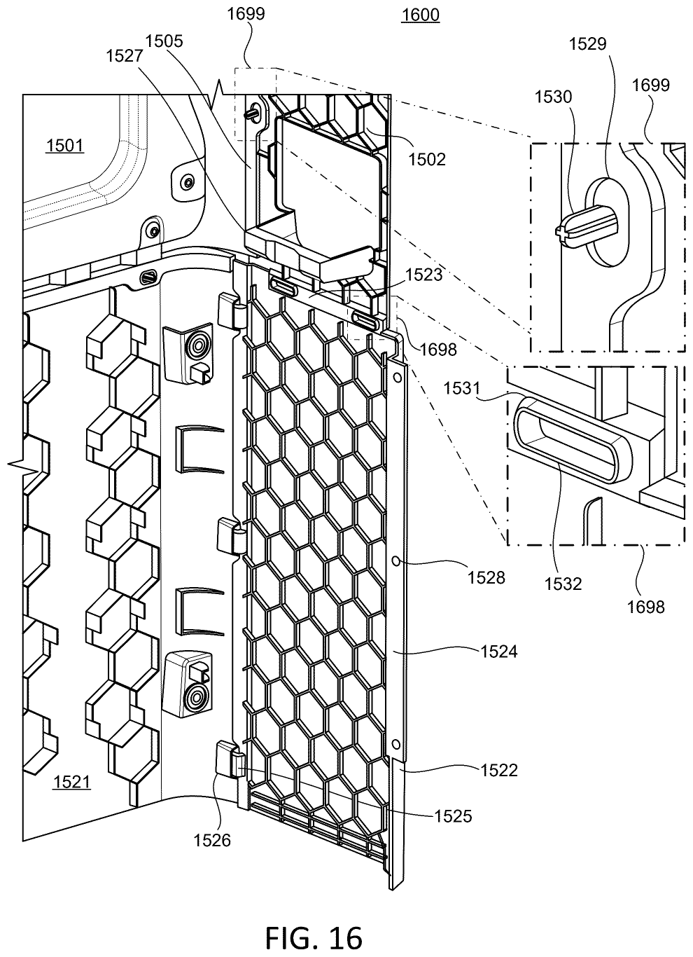

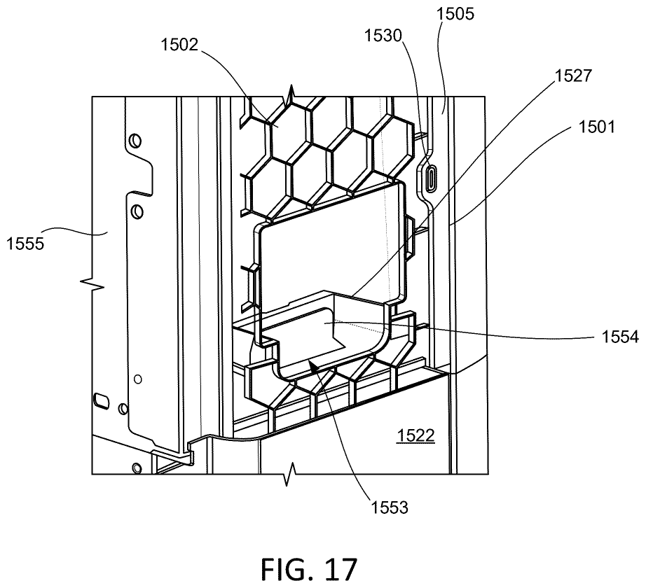

FIG. 15 is a schematic illustration of removable panels, in accordance with embodiments of the disclosure. In particular, FIG. 15 shows an upper portion of the first through third removable panels as assembled. FIG. 16 is a schematic illustration of removable panels, in accordance with embodiments of the disclosure. In particular, FIG. 16 shows a perspective view of lower portion 1600 of the first, second, fourth, and fifth removable panels as assembled, with enlargements of regions 1698 and 1699. FIG. 17 shows a perspective view of removable panels, in accordance with embodiments of the disclosure. In particular, FIG. 17 shows a semi-transparent view of second removable panel 1502 coupled to first removable panel 1501. FIGS. 15-17 are herein described together for brevity.

Referring to FIGS. 15 and 16, first removable panel further 1501 includes first panel side flange 1505 having first alignment feature 1503 and third alignment feature 1529. In some embodiments, first alignment feature 1503 is any one of a hole or a four-way locator. In some embodiments, third alignment feature 1529 is any one of a slot, vertical slot, or a two-way locator. Second removable panel 1502 includes second alignment feature 1504 (e.g., configured to engage with first alignment feature 1503), fourth alignment feature 1530, second panel lower flange 1523 having thirteenth alignment feature 1531, first support feature 1527, magnetic feature 1507, and standoff 1508. In some embodiments, first support feature 1527 is a second panel loop that forms an opening. Referring to FIG. 17, the frame includes second support feature 1554. In some embodiments, second support feature 1554 includes any one of a hook or a tab. First support feature 1527 engages second support feature 1554 to support second removable panel 1502. In some embodiments, the first and second support features provide support at a lower portion of second removable panel 1502 while an upper portion of second removable panel 1502 is pushed, pivoted, or rotated towards the frame. In some embodiments, the first and second support features provide support while second removable panel 1502 is attached to frame 1555.

Referring to FIGS. 15-17, in some embodiments, the second and fourth alignment features are pins. The second and fourth alignment features engage (e.g., are inserted into) the first and third alignment features, respectively, to couple second removable panel 1502 to first removable panel 1501. In some embodiments, the first and second support features provide support while second removable panel 1502 is rotated so the second and fourth alignment features engage the first and third alignment features.

Referring to FIG. 15, magnetic feature 1507 engages magnetic feature 1507 of frame 1555 to hold second removable panel 1502 to frame 1555. In some embodiments, magnetic feature 1507 is any one of a magnet, magnetic material, or ferromagnetic material. In some implementations, magnetic feature 1507 of second removable panel 1502 is one of a magnet or ferromagnetic material and the magnetic material is the other of the magnet or ferromagnetic material. In some embodiments, magnetic feature 1507 holds second removable panel 1502 to frame 1555 when the second and fourth alignment features engage the first and third alignment features. In some embodiments, the magnet holds second removable panel 1502 to frame 1555 to enable standoff 1508 of second removable panel 1502 to be attached to frame 1555. Standoff 1508 includes standoff fastener opening 1510 and a cavity. In some embodiments, standoff fastener opening 1510 is any one of thru-hole 1528 or threaded insert. In some embodiments, a fastener disposed through frame 1555 engages standoff fastener opening 1510 to attach second removable panel 1502 to frame 1555. In some implementations, standoff cavity 1509 provides room for a tool to tighten the fastener. In some embodiments, standoff 1508 is sized to provide a standoff distance or gap between second removable panel 1502 and frame 1555.

Referring to FIG. 16, fourth removable panel 1521 further includes second retaining feature 1526. Fifth removable panel 1522 includes fourteenth alignment feature 1532, fifth panel flange 1524 having a thru-hole, and first retaining feature 1525. Fourteenth alignment feature 1532 engages (e.g., is inserted into) thirteenth alignment feature 1531 to couple fifth removable panel 1522 to the second removable panel 1502. In the embodiment depicted, fourteenth alignment feature 1532 is a pin, and thirteenth alignment feature 1531 is a horizontal slot. The horizontal slot guides movement of fifth removable panel 1522 towards and away from fourth removable panel 1521 and aligns first retaining feature 1525 to engage second retaining feature 1526. In some embodiments, second retaining feature 1526 is a slot, and first retaining feature 1525 is a tab that engages the slot to attach fifth removable panel 1522 to fourth removable panel 1521. In some embodiments, fifth panel flange 1524 and thru-holes 1528 are used to attach fifth removable panel 1522 to any one of frame 1555 or system lower panel.

In some embodiments, the third removable panel includes any of second alignment feature 1504, fourth alignment feature 1530, second panel lower flange 1523, first support feature 1527, magnet, and standoff 1508. In some embodiments, the third removable panel is a mirrored version of second removable panel 1502 without the removable panel module and removable panel holster openings. In some embodiments, the sixth removable panel includes any of fourteenth alignment feature 1532, fifth panel flange 1524 having thru-hole 1528, and first retaining feature 1525. In some embodiments, the sixth removable panel is a mirrored version of fifth removable panel 1522.

In some embodiments, the alignment features maintain spacing 1506 between the removable panels without requiring tight tolerances for features of the removable panels. In some embodiments, at least one of the alignment features are reversed. In one example, referring to FIG. 16, thirteenth alignment feature 1531 is a pin, and fourteenth alignment feature 1532 is a slot. In some implementations, second panel lower flange 1523 is on an exterior of fifth removable panel 1522. In another example, second retaining feature 1526 is a tab, and first retaining feature 1525 is a slot that engages the slot.

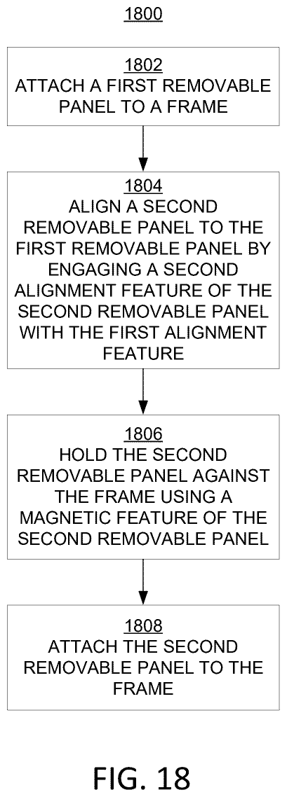

FIG. 18 is a flowchart of illustrative process 1800 for assembling removable panels (e.g., removable panels illustrated in any of FIGS. 1A, 1B, 5-7B, and 13A, 13B, 14A, and 15-17) of a vehicle charging system (e.g., vehicle charging systems 100, 900, 1100, and 1300 of FIGS. 1A, 1B, 9A, 11, and 13A-13B), in accordance with embodiments of the disclosure.

Step 1802 includes attaching a first removable panel (e.g., first removable panel in FIGS. 1A, 13A, 13B, 14A, and 15-17) to a frame (e.g., frame in FIGS. 9A, 9C, 14B, and 17). In some embodiments, the first removable panel includes a first alignment feature, such as discussed in relation to FIG. 15. Step 1802 may include engaging alignment features, retention features, fasteners, or any other suitable features to attach and secure the first removable panel.

Step 1804 includes aligning a second removable panel (e.g., second removable panel in FIGS. 1A, 5-7B, 13A, and 15-17) to the first removable panel by engaging a second alignment feature of the second removable panel with the first alignment feature, such as discussed in relation to FIG. 15.

Step 1806 includes holding the second removable panel against the frame using a magnetic feature of the second removable panel, such as discussed in relation to FIG. 15.

Step 1808 includes attaching the second removable panel to the frame, such as discussed in relation to FIG. 15. Step 1808 may include engaging alignment features, retention features, fasteners, or any other suitable features to attach and secure the second removable panel.

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. An apparatus, comprising:
a holster support;
a holster skin forming a cavity to receive a charging cable coupler; and
a retention feature configured to retain the charging cable coupler in the cavity of the holster skin, wherein:
the holster skin is removably coupled to the holster support and configured to be disposed between the holster support and the charging cable coupler.

2. The apparatus of claim 1, wherein:
the cavity is formed having an entry portion and a retaining portion;
the entry portion is configured to guide the charging cable coupler to the retaining portion; and
the retaining portion is configured to receive the charging cable coupler.

3. The apparatus of claim 2, wherein the retaining portion is configured to form a friction fit with the charging cable coupler to retain the charging cable coupler in the cavity.

4. The apparatus of claim 2, wherein the retention feature comprises a pin coupled to the holster support and disposed between two sidewalls of the retaining portion of the cavity.

5. The apparatus of claim 1, wherein the holster support comprises support ribs configured to support a force of the charging cable coupler when the charging cable coupler is retained.

6. The apparatus of claim 1, wherein the holster support comprises locator ribs configured to limit movement of the charging cable coupler in a vertical direction and permit movement of the charging cable coupler in a horizontal direction.

7. The apparatus of claim 1, wherein the holster skin (i) forms an opening or (ii) comprises a semi-transparent or transparent material, configured to receive light from a light source to illuminate the cavity.

8. The apparatus of claim 1, further comprising a removable panel having an opening, wherein the holster skin is arranged such that the cavity of the holster skin at least partially passes through the opening and the charging cable coupler extends through the opening when the charging cable coupler is retained in the cavity of the holster skin.

9. The apparatus of claim 8, wherein the holster skin comprises a tab configured to engage a slot of the removable panel to attach the holster skin to the removable panel.

10. A vehicle charging system, comprising:
a charging cable comprising a coupler configured to couple to a charging port of a vehicle;
a removable panel;
a holster support attached to the removable panel;
a holster skin forming a cavity to receive the coupler; and
a pin configured to engage a latch of the coupler to retain the coupler in the cavity of the holster skin, wherein the holster skin is removably coupled to the holster support and configured to be disposed between the holster support and the coupler.

11. A method, comprising:
coupling a holster skin to a holster support of a vehicle charging system, wherein:
the holster skin forms a cavity to receive a charging cable coupler; and
a retention feature is configured to retain the charging cable coupler in the cavity of the holster skin.

12. The method of claim 11, further comprising attaching the holster skin to a removable panel of the vehicle charging system such that the cavity of the holster skin at least partially passes through an opening in the removable panel, wherein the charging cable coupler extends through the opening when the charging cable coupler is retained in the cavity.

13. The method of claim 12, wherein attaching the holster skin to the removable panel comprises inserting a tab of the holster skin into a slot of the removable panel.

14. The method of claim 11, further comprising attaching the holster support to the vehicle charging system.

15. The method of claim 11, further comprising attaching the holster support to at least one of a removable panel or a removable module of the vehicle charging system.

16. The method of claim 11, wherein:
the cavity is formed having an entry portion and a retaining portion;
the entry portion is configured to guide the charging cable coupler to the retaining portion; and
the retaining portion is configured to receive the charging cable coupler.

17. The method of claim 16, wherein:
the retention feature comprises a pin coupled to the holster support and disposed between two sidewalls of the retaining portion of the cavity.

18. The method of claim 11, further comprising supporting a force of the charging cable coupler when the charging cable coupler is retained using support ribs of the holster support.

19. The method of claim 11, further comprising forming the holster skin as a single, unitary component.

20. The method of claim 11, further comprising, after coupling the holster skin:
decoupling the holster skin from the holster support.
